(19) United States
(12) Patent Application Publication
(10) Pub. No.: US 2014/0056286 A1
(43) Pub. Date: Feb. 27, 2014

(54) WIRELESS COMMUNICATION SYSTEM AND WIRELESS SLAVE AND MASTER UNITS USED THEREIN

(71) Applicant: Masahiro Nagata, Osaka (JP)

(72) Inventor: Masahiro Nagata, Osaka (JP)

(73) Assignee: PANASONIC CORPORATION, Osaka (JP)

(21) Appl. No.: 14/000,447

(22) PCT Filed: Feb. 22, 2012
(86) PCT No.: PCT/JP2012/001196

§ 371 Date: Aug. 20, 2013

(30) Foreign Application Priority Data
Feb. 11, 2011 (JP) 2011-036453
Feb. 22, 2011 (JP) 2011-036455
Feb. 22, 2011 (JP) 2011-036458
Feb. 22, 2012 (JP) 2012-035726
Feb. 22, 2012 (JP) 2012-035729

(51) Int. Cl. H04W 56/00; H04L 5/00

(52) U.S. Cl. CPC H04W 56/001; H04L 5/003
USPC 370/336

(57) ABSTRACT

In a wireless communication system, slave units such as operation switches and the like are configured such that the higher the priority level of an information signal to be transmitted from each slave unit is, the shorter a period t1 of a carrier sense to be performed before the transmission is set. Therefore, when the slave units attempt to transmit information signals of different priority levels by using the same time slot, one of the slave units whose information signal to be transmitted is of the highest priority level is given the shortest carrier sense period t1 before the transmission of the information signal, and therefore, can transmit the information signal at the earliest timing. Accordingly, by causing the slave unit which becomes able to transmit the information signal at the earliest timing to transmit the information signal, the information signal of the highest priority level can be transmitted at the earliest timing, while the other units are caused to sense, by carrier sense, the transmission, and put off transmission of their own information signals.

### TECHNICAL FIELD

The present invention relates to a wireless communication system in which information signals are transmitted from wireless slave units to a wireless master unit by using radio waves, and a wireless slave unit and a wireless master unit used therein.

### BACKGROUND ART

Conventionally, a wireless communication system has been known, in which a plurality of wireless slave units transmit various information signals to a wireless master unit by a slotted ALOHA scheme using a carrier wave of the same frequency. In this wireless communication system, the wireless slave units are synchronized with time slots into which time is divided at regular intervals, and transmit the information signals by using arbitrary time slots, respectively. When transmitting the information signal, each wireless slave unit performs, in advance of the transmission, carrier sense to check for a predetermined time whether a radio wave is being transmitted from another slave unit, in order to avoid interference between a radio wave from the wireless slave unit and a radio wave from another slave unit.

In the above wireless communication system, there might be a situation where transmission timings of the information signals from the plurality of wireless slave units overlap with each other, and the radio waves interfere with each other, and eventually, none of the information signals can be transmitted. In such a situation, the radio wave interference may be detected and the information signals may be retransmitted. However, there is a possibility that transmission timings of the retransmitted signals might collide with each other again and the radio waves might interfere with each other. As a technique for avoiding such radio wave interference, the following technique has been known. That is, in a plurality of radio stations whose transmission timings have collided with each other in a first try, carrier sense periods are set, in a second try, at random within a predetermined time range, and a radio station having the shortest carrier sense period is caused to transmit an information signal. In this technique, the radio stations that have put off transmission in the second try are assigned with carrier sense periods for a third try, at random within a time range shorter than the above-mentioned predetermined time range. Then, an information signal is transmitted from one of those radio stations (refer to Japanese Laid-Open Patent Publication No. 10-145318, for example).

It is noted that there has been known a wireless slave unit which communicates with a wireless master unit by TDMA (Time Division Multiple Access). A kind of this wireless slave unit receives a beacon signal periodically transmitted from the wireless master unit, and transmits a signal to the wireless master unit, in synchronization with time slots defined by the beacon signal.

FIGS. 36(a) and (b) show a configuration of this kind of wireless slave unit. As shown in FIG. 36(a), the wireless slave unit 100 includes: a wireless transmission/reception circuit 101; and a microcomputer for control (hereinafter referred to as a control microcomputer) 102 that controls communication of the wireless transmission/reception circuit 101.

The wireless transmission/reception circuit 101 includes: a wireless communication oscillator 103 that generates a wireless communication clock signal for determining a carrier frequency of a signal to be transmitted; and a baseband circuit 104. The baseband circuit 104 counts time based on the wireless communication clock signal supplied from the wireless communication oscillator 103, and defines time slots. Further, the wireless transmission/reception circuit 101 includes: a modulation circuit 106 that modulates the signal to be transmitted, and transmits the modulated signal from an antenna 105 to the wireless master unit; and a demodulation circuit 107 that demodulates a signal received via the antenna 105.

The wireless communication oscillator 103 includes: a quartz resonator 103a; and a PLL synthesizer 103b that frequency-divides a clock signal generated from the quartz resonator 103a, and outputs the frequency-divided clock signal as a wireless communication clock signal. The modulation circuit 106, by using the wireless communication clock signal outputted from the wireless communication oscillator 103, up-converts the frequency of the modulated signal to a carrier frequency determined by the wireless communication clock signal. The demodulation circuit 107 down-converts the reception signal received by the antenna 105 by using the wireless communication clock signal, and demodulates the down-converted signal.

As shown in FIG. 36(b), the baseband circuit 104 includes a decoder 104a, a slot management timer 104b, an encoder 104c, and a clock generation circuit 104d. The decoder 104a decodes the signal demodulated by the demodulation circuit 107, and detects a beacon signal from the wireless master unit. The slot management timer 104b counts time from the beacon signal detection timing by the decoder 104a, and defines a time slot. The encoder 104c encodes the signal to be transmitted to a transmission format, and sends the encoded signal to the modulation circuit 106 in synchronization with the time slot defined by the slot management timer 104b. The clock generation circuit 104d generates an operation clock signal suitable for driving of each component in the baseband circuit 104, based on the wireless communication clock signal outputted from the wireless communication oscillator 103.

As described above, in the above wireless slave unit, the wireless communication clock signal is supplied to the baseband circuit 104, and the baseband circuit 104 counts time based on the wireless communication clock signal, and defines a time slot. Since the wireless communication clock signal generally has a frequency of several tens [MHz] and is a high speed signal, the wireless slave unit has a drawback that current consumption due to the baseband circuit 104 increases.

There has been known a wireless slave unit that counts time by using an operation clock signal of a control microcomputer, having a lower frequency than the wireless communication clock signal, and adjusts communication timing with a wireless master unit (refer to Japanese Laid-Open Patent Publication No. 2010-2201104, for example). Since, in this wireless slave unit, the accuracy and precision of an oscillation frequency of an operation clock oscillator that outputs the operation clock signal are not very high, the wireless slave unit corrects a count time error, based on reception timing of a signal periodically transmitted from the wireless master unit.

However, jitter is likely to occur in the signal transmitted from the wireless master due to influence from propagation environment, and arrival timing of the signal to the wireless slave unit is sometimes delayed from normal timing. In the wireless slave unit disclosed in Patent Document 1, since the count time error is corrected by using the reception timing of the signal, it is difficult to perform highly accurate correction, and the time count precision is degraded.

### SUMMARY OF THE INVENTION

By the way, in the wireless communication system having the countermeasure against radio wave interference as described in Japanese Laid-Open Patent Publication No. 10-145318, it is assumed that transmission priority levels of various information signals transmitted from the wireless slave units are different from each other. In this wireless communication system, if a plurality of wireless slave units attempt to transmit the information signals of different priority levels by using the same time slot, an information signal of higher priority level is not necessarily transmitted preferentially even when the above-mentioned radio wave interference avoidance technique is used.

The present invention is made to solve the above problems. An object of the present invention is to provide: a wireless communication system in which, when a plurality of wireless slave units attempt to transmit, by using the same time slot, information signals of different priority levels to a wireless master unit, transmission of an information signal of higher priority level is prioritized with reliability; and a wireless slave unit and a wireless master unit used in the wireless communication system.

In order to achieve the above object, a wireless communication system of the present invention includes: a wireless master unit; and a plurality of wireless slave units which receive a beacon signal periodically wirelessly transmitted from the wireless master unit, and wirelessly transmit a plurality of kinds of information signals to the wireless master unit, respectively, in synchronization with time slots defined by the beacon signal. The plurality of kinds of information signals have previously been assigned with priority levels. Each of the plurality of wireless slave units is configured such that the higher the priority level of the information signal to be transmitted from the wireless slave unit is, the shorter a period of a carrier sense to be performed before the transmission is set.

According to the present invention, when the plurality of wireless slave units attempt to transmit information signals of different priority levels by using the same time slot, one of the wireless slave units whose information signal is of the highest priority level is given the shortest carrier sense period before the transmission, and therefore, can transmit the information signal at the earliest timing. Accordingly, by causing the wireless slave unit which becomes able to transmit the information signal at the earliest timing to transmit the information signal, the information signal of the highest priority level can be transmitted at the earliest timing, while the other units are caused to sense, by carrier sense, the transmission, and put off transmission of their own information signals. Therefore, transmission of the information signal of the highest priority level can be reliably prioritized.

Further, a wireless slave unit of the present invention is used in the above-mentioned wireless communication system.

Further, a wireless master unit of the present invention is used in the above-mentioned wireless communication system.

Further, a wireless slave unit of the present invention includes: a wireless transmission/reception circuit which receives a beacon signal periodically wirelessly transmitted from a wireless master unit, and wirelessly transmits various signals to the wireless master unit, in synchronization with time slots defined by the beacon signal; a microcomputer which controls a process of transmitting the various signals from the wireless transmission/reception circuit; and an operation clock oscillator which generates an operation clock signal for the microcomputer. The wireless transmission/reception circuit includes a wireless communication oscillator which generates a wireless communication clock signal for determining a carrier frequency of a signal to be transmitted. The microcomputer includes: a timer which counts time based on the operation clock signal generated from the operation clock oscillator; a time slot definition circuit which defines the time slots by using the timer, starting from the reception timing of the beacon signal by the wireless transmission/reception circuit; and a count time value correction circuit which corrects a count time value obtained by the timer, based on the wireless communication clock signal generated from the wireless communication oscillator.

According to the present invention, the timer counts time by using the operation clock signal of the microcomputer. Therefore, current consumption of the timer can be suppressed as compared to a case where time is counted by using, for example, a wireless communication clock signal that is set at a higher frequency than the operation clock signal. Further, time count of the timer is corrected by using a wireless communication clock signal, and generally, an oscillation frequency of a wireless communication oscillator that generates a wireless communication clock signal is highly accurate and precise. Therefore, time count precision is enhanced. As a result, a shift of the time slots of the wireless slave unit from those of the wireless master unit can be reduced, thereby enhancing communication accuracy.

### BRIEF DESCRIPTION OF THE DRAWINGS

FIG. 1 is a diagram showing a configuration of an equipment control system including a wireless communication system according to a first embodiment of the present invention.

FIG. 2 is an electric block diagram of the wireless communication system.

FIG. 3 is a diagram showing the priority levels of various signals in the wireless communication system.

FIG. 4 is a communication operation chart of the wireless communication system.

FIG. 5 is a diagram showing control contents of the various signals at transmission.

FIG. 6 is a diagram showing control contents of various signals at transmission in a wireless communication system according to a first modification of the above embodiment.

FIG. 7 is a communication operation chart of the wireless communication system.

FIG. 8 is a plan view showing an example of construction of a wireless communication system according to a second modification of the above embodiment.

FIG. 9 is a diagram showing control contents of various signals at transmission in the wireless communication system.

FIG. 10 is a communication operation chart of the wireless communication system.

FIG. 11 is a diagram showing a structure of a beacon signal of a wireless communication system according to a third modification of the above embodiment.

FIG. 12 a diagram showing communication setting and communication operation of a wireless communication system according to a first reference example of the above embodiment.

FIG. 13 is an electric block diagram of a wireless communication system according to a second reference example of the above embodiment.

FIG. 14 is a diagram showing priority levels and transmission powers of various signals in the wireless communication system.

FIG. 15 is an electric block diagram showing a configuration of a wireless communication system according to a second embodiment of the present invention.

FIG. 16(a) is an electric block diagram showing a configuration of an operation switch provided in the above wireless communication system, and FIG. 16(b) is an electric block diagram showing a configuration of a control microcomputer of the operation switch.

FIG. 17 is a communication operation chart of the wireless communication system.

FIG. 18(a) is an electric block diagram showing a configuration of an operation switch in a wireless communication system according to a first modification of the above embodiment, and FIG. 18(b) is an electric block diagram showing a configuration of a control microcomputer of the operation switch.

FIG. 19 is an electric block diagram showing a configuration of a wireless communication system according to a second modification of the above embodiment.

FIG. 20 is a communication operation chart of the wireless communication system.

FIG. 21 is a communication operation chart in a case where transmission timing of a beacon signal by a wireless receiver in a wireless communication system is delayed.

FIG. 22 is an electric block diagram showing a configuration of an equipment control system according to a first reference embodiment of the present invention.

FIG. 23 is an electric block diagram showing configurations of a passive infrared sensor, a wireless receiver, and an operation switch in the equipment control system.

FIG. 24 is a flowchart of a communication control process in the passive infrared sensor.

FIG. 25 is a diagram showing transmission timings of signals in the passive infrared sensor.

FIG. 26 is a flowchart of a state switching process in the passive infrared sensor.

FIG. 27 is a diagram showing a communication method and a communication operation chart of the equipment control system.

FIG. 28 is a diagram showing timings at which the wireless receiver transmits a state information signal in accordance with the communication method.

FIG. 29 is a flowchart of a reception process in a downlink-dedicated time slot in the passive infrared sensor.

FIG. 30 is a flowchart of a communication control process in a conventional passive infrared sensor.

FIG. 31 is a diagram showing transmission timings of ON signals in the passive infrared sensor.

FIG. 32 is an electric block diagram showing a configuration of an equipment control system according to a first modification of the above reference embodiment.

FIG. 33 is a communication operation chart of the equipment control system.

FIG. 34 is an electric block diagram showing a configuration of an equipment control system according to a second modification of the above reference embodiment.

FIG. 35 is a communication operation chart of the equipment control system.

FIG. 36(a) is an electric block diagram showing a configuration of a conventional wireless slave unit, and FIG. 36(b) is an electric block diagram showing a configuration of a control microcomputer of the wireless slave unit.

### DESCRIPTION OF THE PREFERRED EMBODIMENTS

### First Embodiment

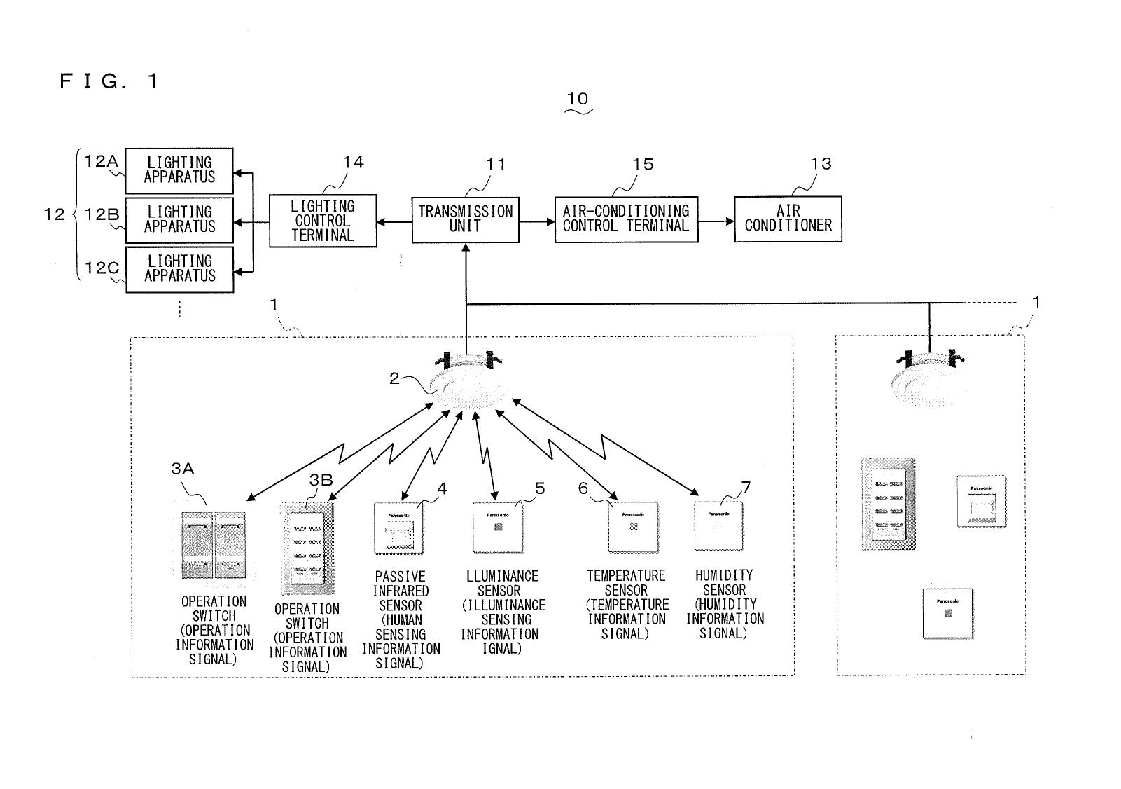

FIG. 1 shows a configuration of an equipment control system including a wireless communication system according to a first embodiment of the present invention. The wireless communication system 1 includes: a wireless receiver (hereinafter referred to as a receiver) 2 serving as a wireless master unit; and a plurality of wireless slave units that wirelessly transmit various information signals to the receiver 2. These wireless slave units include operation switches 3A and 3B, a passive infrared sensor 4, an illuminance sensor 5, a temperature sensor 6, and a humidity sensor 7 (hereinafter collectively referred to as operation switch 3A and the like). The number of the operation switches is not limited to that shown in FIG. 1. One operation switch or a plurality of operation switches may be provided.

The equipment control system 10 includes a wireless communication system 1 (the receiver 2 and the operation switch 3A and the like), a transmission unit 11, lighting apparatuses 12A, 12B, . . . (hereinafter collectively referred to as lighting apparatus 12A and the like), an air conditioner 13, a lighting control terminal 14, and an air-conditioning control terminal 15. The receiver 2 receives various information signals wirelessly transmitted from the operation switch 3A and the like. A reception area of the receiver 2 is, for example, about 40 m×40 m. The transmission unit 11 transmits the various information signals received by the receiver 2 to the lighting control terminal 14 and the air-conditioning control terminal 15 via wires. The lighting control terminal 14 and the air-conditioning control terminal 15 control the lighting apparatus 12A and the like and the air conditioner 13, respectively, based on the various information signals transmitted from the transmission unit 11. The number of the lighting apparatus 12A and the like is not limited to that shown in FIG. 1. One lighting apparatus or a plurality of lighting apparatuses may be provided. The equipment control system 10 is preferably installed in, for example, an office building, a factory, a hall, a store, and the like.

Each operation switch 3A, 3B, the passive infrared sensor 4, the illuminance sensor 5, the temperature sensor 6, and the humidity sensor 7 wirelessly transmit an operation information signal, a human sensing information signal, an illuminance information signal, a temperature information signal, and a humidity information signal, respectively, to the receiver 2 via radio waves. The receiver 2 and the operation switch 3A and the like communicate with each other by using a carrier wave of the same frequency. The receiver 2 and the operation switch 3A and the like are mounted on a ceiling, a wall, or the like of a building.

The transmission unit 11 allocates each of the various information signals received by the receiver 2 to a destination depending on the type of the information signal. For example, the transmission unit 11 transmits the operation information signal, the human sensing information signal, and the illuminance information signal to the lighting control terminal 14, and transmits the temperature information signal and the humidity information signal to the air-conditioning control terminal 15.

The lighting control terminal 14 controls ON and OFF of the lighting apparatuses 12A and the like, based on the operation information signal and the human sensing information signal transmitted from the transmission unit 11. In addition, the lighting control terminal 14 controls dimming of the lighting apparatus 12A and the like, based on the illuminance information signal transmitted from the transmission unit 11. These controls may be performed in units of groups into which the lighting apparatus 12A and the like are divided, or may be collectively performed on all the lighting apparatus 12A and the like. The air-conditioning control terminal 15 performs ON/OFF switching of the air conditioner 13, control of temperature setting of the air conditioner 13, and the like, based on the temperature information signal and the humidity information signal transmitted from the transmission unit 11. A wiring method between the receiver 2, and the lighting control terminal 14 and the air-conditioning control terminal 15 is a two-line method using two signal lines of predetermined voltages of different polarities. A communication method between them is a time division multiplexing transmission method such as polling/selecting.

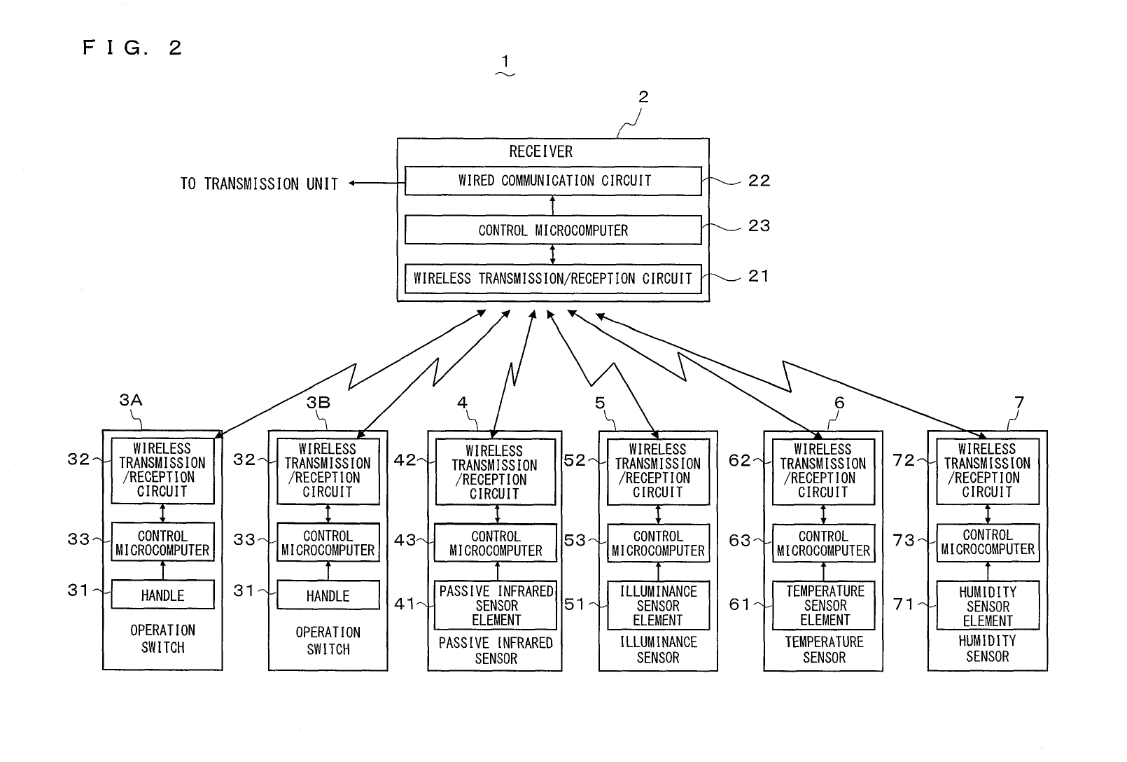

FIG. 2 shows a specific configuration of the wireless communication system 1. The receiver 2 includes: a wireless transmission/reception circuit 21 that wirelessly communicates with the operation switch 3A and the like; a wired communication circuit 22 that communicates with the transmission unit 11 (refer to FIG. 1) via a wire; and a microcomputer for control (hereinafter referred to as a control microcomputer) 23. The control microcomputer 23 performs communication control for the wireless transmission/reception circuit 21 and the wired communication circuit 22. For example, the control microcomputer 23 controls the wired communication circuit 22 so as to transmit the various information signals from the operation switch 3A and the like received by the wireless transmission/reception circuit 21, to the transmission unit 11.

Each operation switch 3A, 3B (operation unit) includes: a handle 31 that allows a user to turn on and off the lighting apparatus 12 or control dimming of the lighting apparatus 12; and a wireless transmission/reception circuit 32 that wirelessly transmits, to the receiver 2, an operation information signal indicating the content of an operation performed on the handle 31 by the user. In addition, the operation switch 3 includes a control microcomputer 33 that performs communication control for the wireless transmission/reception circuit 32.

The passive infrared sensor (human sensing sensor) 4 (event sensing sensor) includes a passive infrared sensor element 41 that senses presence of a human being (event) when the human being is present in a sensing area (when an event occurs). In addition, the passive infrared sensor 4 includes: a wireless transmission/reception circuit 42 that wirelessly transmits a human sensing information signal (event information signal) from the passive infrared sensor element 41 to the receiver 2; and a control microcomputer 43 that performs communication control for the wireless transmission/reception circuit 42.

The illuminance sensor 5 (event sensing sensor) includes: an illuminance sensor element 51 that senses illuminance in the environmental atmosphere; a wireless transmission/reception circuit 52; and a control microcomputer 53. When the illuminance sensed by the illuminance sensor element 51 exceeds a threshold (when an event occurs), the control microcomputer 53 detects it. The wireless transmission/reception circuit 52 wirelessly transmits an illuminance sensing information signal (event information signal) indicating that the illuminance sensed by the illuminance sensor element 51 exceeds the threshold, and the sensed illuminance, to the receiver 2, under control of the control microcomputer 53.

The temperature sensor 6 (periodic measurement sensor) includes: a temperature sensor element 61 that periodically measures the temperature (physical quantity) in the environmental atmosphere; and a wireless transmission/reception circuit 62 that wirelessly transmits a temperature information signal (physical quantity information signal) indicating the temperature measured by the temperature sensor element, to the receiver 2. In addition, the temperature sensor 6 includes a control microcomputer 63 that controls the temperature measurement of the temperature sensor element 61 and the communication of the wireless transmission/reception circuit 62. The control microcomputer 63 causes the temperature sensor element 61 to measure the temperature, for example, once every minute, and causes the wireless transmission/reception circuit 62 to transmit the temperature information signal once every second.

The humidity sensor 7 (periodic measurement sensor) includes: a humidity sensor element 71 that periodically measures the humidity (physical quantity) in the environmental atmosphere; and a wireless transmission/reception circuit 72 that wirelessly transmits a humidity information signal (physical quantity information signal) indicating the humidity measured by the humidity sensor element, to the receiver 2. In addition, the humidity sensor 7 includes a control microcomputer 73 that controls the humidity measurement of the humidity sensor element 71 and the communication of the wireless transmission/reception circuit 72. The control microcomputer 73 causes the humidity sensor element 71 to measure the humidity, for example, once every several tens of seconds, and causes the wireless transmission/reception circuit 72 to transmit the humidity information signal once every second.

Hereinafter, for convenience of description, the control microcomputers 33, 43, 53, 63, and 73 are referred to as “control microcomputer 33 and the like”, and the wireless transmission/reception circuits 32, 42, 52, 62, and 72 are referred to as “wireless transmission/reception circuits 32 and the like”.

The slotted ALOHA scheme is adopted as a communication method between the receiver 2 and the operation switch 3A and the like, and the wireless transmission/reception circuit 21 periodically wirelessly transmits a beacon signal that defines time slots. The wireless transmission/reception circuit 32 and the like receive the beacon signal periodically wirelessly transmitted from the wireless transmission/reception circuit 21, and wirelessly transmit various information signals to the receiver 2 in synchronization with the time slots defined by the beacon signal. The wireless transmission/reception circuit 21 also transmits other signals to the wireless transmission/reception circuit 32 and the like, in synchronization with the time slots defined by the beacon signal transmitted by the wireless transmission/reception circuit 21. The communication method and the communication operation will be described later in detail.

The control microcomputer 33 and the like assign the signals to be transmitted by the wireless transmission/reception circuit 32 and the like with inherent identification information of the operation switch 3A and the like, as transmission source address information, and with inherent identification information of any of the wireless slave units excluding the operation switch 3, as transmission destination address information. Then, the control microcomputer 33 and the like cause the wireless transmission/reception circuit 32 and the like to perform a reception process, when the transmission-destination inherent identification information assigned to the signals received by the wireless transmission/reception circuit 32 and the like coincides with the inherent identification information of the operation switch 3. Such a process of distinguishing the transmission source and the transmission destination is also performed by the control microcomputer 23 with the wireless transmission/reception circuit 21.

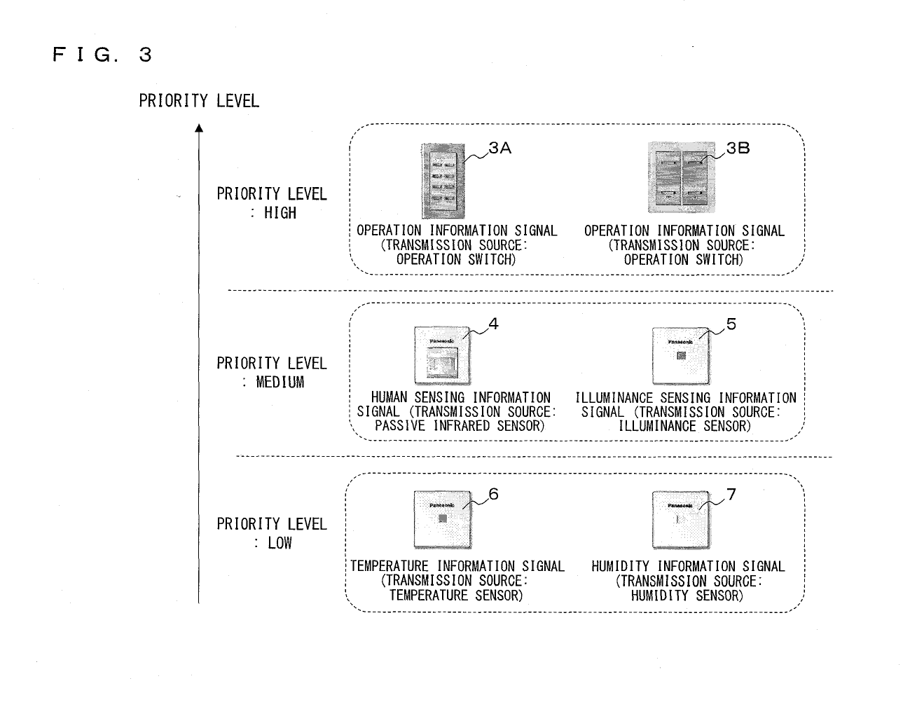

FIG. 3 shows priority levels of the various information signals transmitted by the operation switch 3A and the like (the operation information signal, the human sensing information signal, the illuminance sensing information signal, the temperature information signal, and the humidity information signal). The various information signals have previously been assigned with the priority levels. In FIG. 3, in accordance with the priority levels of the various information signals, the operation switch 3A and the like that are the transmission sources of the information signals are ranked.

The reason why the priority levels are set is as follows. That is, the operation information signal is transmitted based on an operation performed on the operation switch 3 by a user. The operation information signal is transmitted not periodically but several times a day, and therefore, the traffic of the operation information signal is less. Accordingly, the operation information signal is highly valuable as a signal.

Further, when the user operates the lighting apparatus 12A and the like (refer to FIG. 1) by using the operation switch 3, if reaction of the lighting apparatus 12A and the like is slow, the user might feel uncomfortable. Therefore, the operation information signal needs to be transmitted quickly, and is high in the level of urgency for transmission (hereinafter referred to as transmission urgency level). Specifically, the operation information signal is desired to arrive at the receiver 2 within a period of 100 ms or less after the user operation. Even when the traffic is congested, it is desirable that the operation information signal arrives at the receiver 2 within a period of 200 ms or less, and is reflected to control of the lighting apparatus 12A and the like.

On the other hand, the human sensing information signal is transmitted from the passive infrared sensor 4 in accordance with movement of a human being, and the illuminance sensing information signal is transmitted from the illuminance sensor 5 in accordance with illuminance change in the atmosphere. Like the operation information signal, each of these sensing information signals is transmitted not periodically but several tens of times or several hundreds of times a day, and therefore, is highly valuable as a signal.

Further, when a human being enters or leaves the sensing area of the passive infrared sensor 4 or when the illuminance in the atmosphere changes, if the lighting apparatus 12A and the like do not react quickly, the user might feel uncomfortable. Therefore, when entrance/leaving of a human being or illuminance change has been sensed, each sensing information signal needs to be quickly transmitted. Accordingly, each sensing information signal is high in the transmission urgency level, and a period from each sensing to transmission of each sensing information signal needs to be as long as that in the case of the operation information signal. However, since the user cannot accurately know the human sensing timing by the passive infrared sensor 4 and the illuminance change sensing timing by the illuminance sensor 5, transmission of each sensing information signal need not be performed as quickly as the transmission of the operation information signal. Further, the passive infrared sensor 4 is desired to be installed away from the lighting area of the lighting apparatus 12A and the like so that, when a human being approaches the lighting area, the passive infrared sensor 4 can sense the presence of the human being as quickly as possible to turn on the lighting apparatus 12A and the like. In this installation method, at a point in time when the passive infrared sensor 4 senses presence of a human being, the human being is still away from the lighting apparatus 12A and the like. Therefore, when the presence of the human being is sensed, even if transmission of the human sensing information signal from the passive infrared sensor 4 is somewhat delayed and thereby reaction of the lighting apparatus 12A and the like is a little delayed, no problem occurs. Accordingly, the transmission urgency level of each sensing information signal may be lower than that of the operation information signal.

On the other hand, the temperature information signal and the humidity information signal are automatically periodically transmitted from the temperature sensor 6 and the humidity sensor 7, respectively, at intervals of several tens of seconds. Accordingly, even if a situation where these information signals do not arrive at the receiver 2 occurs several times, such situation has little influence. Therefore, it is found that the values of these information signals are lower than those of the operation information signal, the human sensing information signal, and the illuminance sensing information signal.

Further, change in the temperature and/or humidity in the atmosphere is not likely to be noticed by a user. Moreover, even if the air conditioner 13 (refer to FIG. 1) quickly responds to the change and changes its operation, the user is not likely to notice the change in the atmosphere caused by the operation change. Accordingly, the reaction of the air conditioner 13 when the temperature or the humidity changes need not be as quickly as the reaction of the lighting apparatus 12A and the like based on an operation, human sensing, or illuminance sensing. Therefore, as for the temperature information signal and the humidity information signal, a transmission delay of about several seconds is within an allowable range, and the transmission urgency levels of these signals are lower than those of the operation information signal, the human sensing information signal, and the illuminance sensing information signal.

As described above, the operation information signal, the human sensing information signal, and the illuminance sensing information signal are of higher importance than the temperature information signal and the humidity information signal. Further, the operation information signal, the human sensing information signal and the illuminance sensing information signal, and the temperature information signal and the humidity information signal have higher transmission urgency levels in this order. Accordingly, each information signal has previously been assigned with a priority level according to the importance and the transmission urgency level of the information signal. The higher the transmission urgency level is, the higher the priority level of the information signal is set. The priority levels of the operation information signal, the human sensing information signal, and the illuminance sensing information signal are higher than those of the temperature information signal and the humidity information signal, and the priority level of the operation information signal is higher than those of the human sensing information signal and the illuminance sensing information signal. The human sensing information signal and the illuminance sensing information signal are of the same priority level, and the temperature information signal and the humidity information signal are of the same priority level. In this way, the priority level of the operation information signal, the priority level of the human sensing information signal and the illuminance sensing information signal, and the priority level of the temperature information signal and the humidity information signal are set to “High”, “Medium”, and “Low”, respectively.

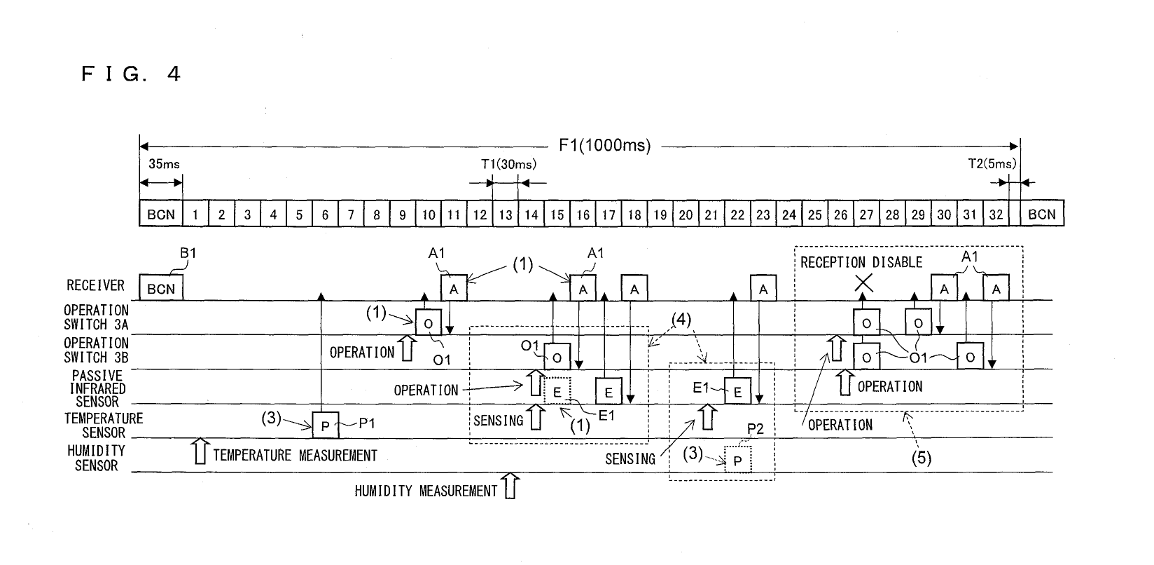

Next, with reference to FIG. 4 as well as FIG. 2, a communication control process performed in the wireless communication system 1 will be described. As described above, the passive infrared sensor 4 and the illuminance sensor 5 are event sensing sensors, and perform similar operations when communicating with the receiver 2. Therefore, the operation of the passive infrared sensor 4 will be described as a representative operation. The same applies to modifications described later. Further, communication in the wireless communication system 1 is actually performed by the wireless transmission/reception circuit 21 and the wireless transmission/reception circuit 32 and the like under control of the control microcomputer 23 and the control microcomputer 33 and the like. However, for convenience of description, the receiver 2 and the operation switch 3A and the like will be described as major units for communication, hereinafter.

FIG. 4 shows examples of the communication method and the communication operation of the wireless communication system 1. The slotted ALOHA scheme is adopted as the communication method of the wireless communication system 1. In this scheme, fundamental units of communication are frames F1 into which time is divided at regular intervals. Each frame F1 is composed of time slots T1 into which time is divided at shorter regular intervals. The receiver 2 and the operation switch 3A and the like are synchronized with the time slots T1, and transmit signals by using arbitrary time slots T1.

The receiver 2 generates a beacon signal B1 (BCN) that defines the time slots T1, and wirelessly transmits the beacon signal B1 to the operation switch 3A and the like. The operation switch 3A and the like receive the beacon signal B1. The receiver 2 and the operation switch 3A and the like each define a time slot T1 based on the transmitted beacon signal B1 and the received beacon signal B1, respectively, and establish synchronization with the time slot T1.

In order to achieve continuous and accurate synchronization establishment, the beacon signal B1 is transmitted periodically (specifically, every frame F1). The beacon signal is provided at the beginning of each frame F1. A vacant period T2 is provided at the end of each frame F1.

The time length of each frame F1 and the time length of each time slot T1 are, for example, 1000 ms and 30 ms, respectively. For example, 32 time slots T1 are provided in each frame F1. The time length of the beacon signal B1 and the vacant period T2 are, for example, 35 ms and 5 ms, respectively.

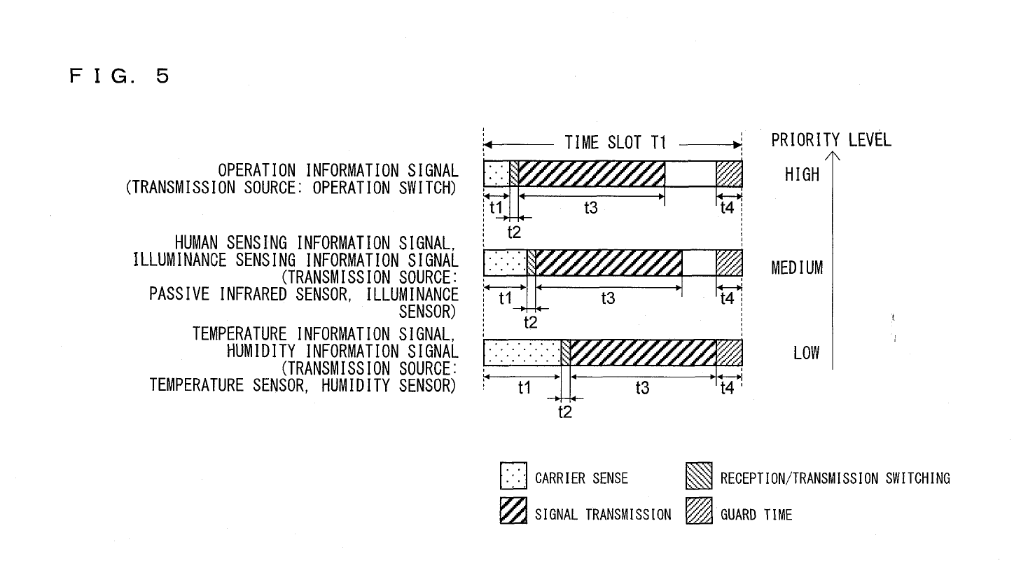

As shown in FIG. 5, when transmitting the various information signals, the operation switch 3A and the like each perform, in advance of transmission, carrier sense to confirm whether an information signal is being transmitted from any other unit, and perform reception/transmission switching if no information signal is being transmitted, and thereafter, transmit the information signal. This series of operations are performed in one time slot T1. There is spare time left between the transmission of the information signal and the end of the time slot T1, and a guard time t4 having no signal is provided in the spare time. The guard time t4 is a period for absorbing a lag in transmission timing caused by a count time error of each of the operation switch 3A and the like. Since the time length of each time slot T1 is, for example, 30 ms, the time lengths of a period for carrier sense (hereinafter referred to as a carrier sense period) t1, a reception/transmission switching period t2, and a signal transmission period t3 are each set within a range from several ms to about 20 ms. The magnitude relationship among the time lengths is t2<t1<t3. The reception/transmission switching period t2 and the signal transmission period t3 each may be uniform among the operation switch 3A and the like, or may vary among the operation switch 3A and the like depending on the types of the wireless slave units.

On the other hand, the carrier sense period t1 varies among the operation switch 3A and the like. As for each of the operation switch 3A and the like, the higher the priority level of the information signal to be transmitted therefrom is, the shorter the period (t1) of carrier sense to be performed before the transmission is set. As described above, the operation information signal O1, the human sensing information signal E1 and the illuminance sensing information signal, and the temperature information signal P1 and the humidity information signal P2 have higher priority levels in this order. Accordingly, the operation switch 3, the passive infrared sensor 4 and the illuminance sensor 5, and the temperature sensor 6 and the humidity sensor 7 have shorter carrier sense periods t1 in this order. The period (t1) of carrier sense performed before transmission of the information signal of the lower priority level is longer than the sum of the period (t1) of carrier sense performed before transmission of the information signal of higher priority level and the reception/transmission switching period t2, and partially overlaps with the signal transmission period t3 of the information signal of higher priority level.

Referring back to FIG. 4, the communication operation of the operation switch 3A and the like will be described with reference to numerals in parentheses in FIG. 4.

(1) When being operated by a user, each operation switch 3A, 3B transmits the operation information signal O1 to the receiver 2, by using a time slot immediately after the user operation. When sensing presence of a human being, the passive infrared sensor 4 transmits the human sensing information signal E1 to the receiver 2.

(2) When receiving the operation information signal O1 and the human sensing information signal E1 from the operation switch 3 and the passive infrared sensor 4, respectively, the receiver 2 transmits, as a response, an acknowledgement signal A1 to the operation switch 3 and to the passive infrared sensor 4. The acknowledgement signal A1 is a signal for notifying completion of reception of each information signal.

(3) The temperature sensor 6 and the humidity sensor 7 periodically transmit the temperature information signal P1 and the humidity information signal P2, respectively, for example, once every 60 frames F1, i.e., once every 60 seconds, by using fixed time slots that have previously been assigned to the sensors 6 and 7, respectively. The time slot assigned to the temperature sensor 6 and the time slot assigned to the humidity sensor 7 are different from each other.

(4) If transmission timings of information signals of different priority levels overlap with each other, a wireless slave unit that transmits an information signal of lower priority level, among the operation switch 3A and the like that attempt to transmit the information signals, detects by carrier sense the overlapping of the transmission timings, and puts off transmission. Then, if the wireless slave unit that puts off transmission is the operation switch 3 or the passive infrared sensor 4, the operation switch 3 or the passive infrared sensor 4 generates random numbers, delays transmission timing by the random numbers, and retransmits the information signal by using a later time slot. If the wireless slave unit that puts off transmission is the temperature sensor 6 or the humidity sensor 7, the temperature sensor 6 or the humidity sensor 7 retransmits the information signal by using the fixed time slot in the next frame F1.

(5) If transmission timings of information signals from operation switches 3 of the same priority level overlap with each other, collision of the information signals occurs. However, these operation switches 3 each detect that an acknowledgement signal A1 that the receiver 2 should return after reception of the information signal is not received in a next slot, and thereby senses collision of the information signals. Then, the operation switches 3 each generate random numbers, delay transmission timing by the random numbers, and retransmit the information signal by using a later time slot. When a plurality of passive infrared sensors 4 are provided, if transmission timings of information signals from these passive infrared sensors 4 overlap with each other, the passive infrared sensors 4 each perform a process similar to the process for the operation switches 3.

In the present embodiment, when the operation switch 3A and the like attempt to transmit the information signals of different priority levels by using the same time slot T1, the higher the priority level of the information signal to be transmitted is, the shorter the carrier sense period t1 before the transmission is set, and thereby the information signal can be transmitted earlier. Accordingly, by causing the wireless slave unit that has become able to transmit the information signal at the earliest timing to transmit the information signal, the information signal of the highest priority level can be transmitted at the earliest timing, while the other unit is caused to sense the transmission by carrier sense, and put off transmission of the information signal. Therefore, it is reliably possible to prioritize transmission of the information signal of higher priority level. Further, collision of the information signals can be avoided, and a situation where none of the information signals is transmitted can be avoided. Accordingly, delay in information signal transmission can be reduced.

Further, as compared to the conventional art, in order to realize the above-mentioned transmission, special hardware need not be added, and only setting of information signal transmission timings by software is needed. Accordingly, size reduction of the operation switch 3A and the like can be achieved.

Further, since the priority levels are set according to the transmission urgency levels, an information signal of higher transmission urgency level is transmitted preferentially, and therefore, the information signals can be transmitted in appropriate order according to the urgency levels thereof.

By the way, the operation information signal O1 is based on an intentional operation by a user to the operation switch 3, and therefore, is highly related to the user action. On the other hand, the human sensing information signal E1 is an information signal generated by the passive infrared sensor 4 that automatically senses the action of a user, and therefore, is less related to the user action as compared to the operation information signal O1. In contrast, the temperature information signal P1 and the humidity information signal P2 are information signals automatically periodically measured by the temperature sensor 6 and the humidity sensor 7, respectively, regardless of the user action, and therefore, are least related to the user action. In the present embodiment, since the operation information signal O1, the human sensing information signal E1, and the temperature information signal P1 and the humidity information signal P2 are preferentially transmitted in this order, these information signals can be transmitted in an appropriate order according to the degree of relation to the user action.

Further, although the transmission cycle of the temperature information signal P1 is the same as that of the humidity information signal P2, since the transmission timings of these information signals do not overlap with each other, collision of these information signals can be avoided. Therefore, the communication accuracy can be enhanced.

Hereinafter, modifications of the above first embodiment will be described with reference to the drawings. The configuration of a wireless communication system of each modification is identical to that of the first embodiment, and therefore, will be described with reference to FIG. 1 again. In addition, in the drawings of each modification, the same components as in the first embodiment are denoted by the same reference numerals.

### First Modification of First Embodiment

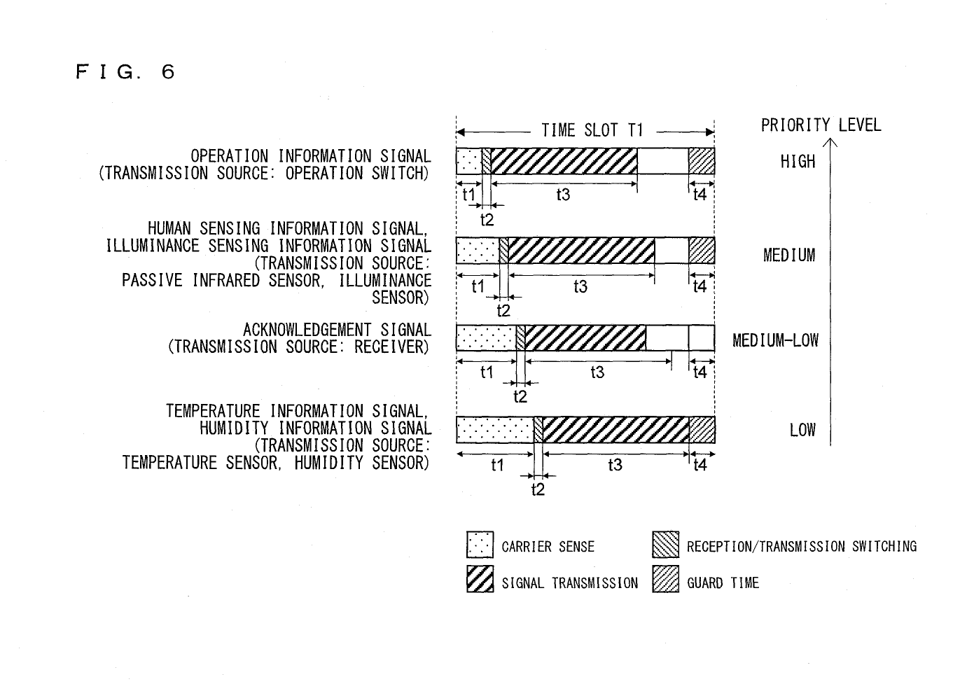

FIG. 6 shows the content of control performed when the receiver 2 and the operation switch 3A and the like of the wireless communication system 1 according to the first modification transmit the various signals. In this modification, when the receiver 2 has received an operation information signal and a human sensing information signal from the operation switch 3 and the passive infrared sensor 4, respectively, the receiver 2 performs carrier sense in advance of transmitting an acknowledgement signal as a response to the operation switch 3 and to the passive infrared sensor 4. The receiver 2, by this carrier sense, confirms whether any other unit is transmitting an information signal. Upon confirming that no other unit is transmitting an information signal, the receiver 2 performs reception/transmission switching, and thereafter, transmits an acknowledgement signal. This series of operations are performed within one time slot T1. There is a spare time left between the signal transmission and the end of the time slot T1, and a guard time t4 having no signal is provided in this spare time.

A priority level has previously been set in the acknowledgement signal A. The higher the priority level of the acknowledgement signal is, the shorter the carrier sense period t1 before transmission of the acknowledgement signal is set by the receiver 2. The priority level of the acknowledgement signal is lower than that of the operation information signal and the human sensing information signal, and is higher than that of the temperature information signal and the humidity information signal. Since the temperature information signal and the humidity information signal are periodically transmitted, these signals are low in the degree of importance of transmission. Therefore, the priority level of the acknowledgement signal is set to be higher than the priority levels of these information signals. Accordingly, the carrier sense period t1 at the time of transmission of the acknowledgement signal is longer than that at the time of transmission of the operation information signal and the human sensing information signal, and is shorter than that at the time of transmission of the temperature information signal and the humidity information signal. The carrier sense period t1 before transmission of the acknowledgement signal partially overlaps with the signal transmission period t3 of each of the operation information signal and the human sensing information signal.

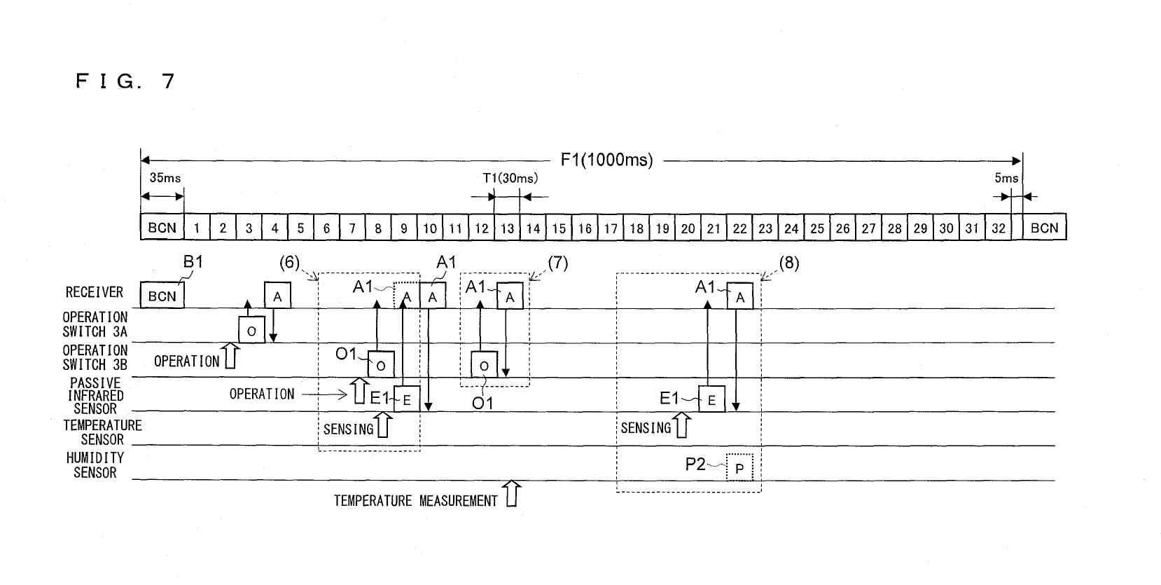

FIG. 7 shows a communication operation of the wireless communication system 1 according to the present modification. The operation will be described with reference to numerals in parentheses in FIG. 7.

(6) When transmission timing of the acknowledgement signal A1 to the operation switch 3 and transmission timing of the human sensing information signal E1 overlap with each other, the receiver 2 detects this overlapping by carrier sense, and puts off or suspends transmission of the acknowledgement signal A1. Thereby, transmission of the human sensing information signal E1 is prioritized, and the passive infrared sensor 4 transmits the human sensing information signal E1 to the receiver 2.

(7) In the above case, the receiver 2 does not retransmit the acknowledgement signal A1. Therefore, the operation switch 3 cannot receive the acknowledgement signal A1, and retransmits the operation information signal O1. Since the operation information signal O1 has already arrived at the receiver 2 by the first transmission, even when the receiver 2 receives the operation information signal O1 retransmitted from the operation switch 3, the receiver 2 may discard the operation information signal O1.

(8) When transmission timing of the humidity information signal P2 and transmission timing of the acknowledgement signal A1 overlap with each other, the humidity sensor 7 senses the overlapping by carrier sense, and puts off transmission of the humidity information signal P2. Then, the receiver 2 preferentially transmits the acknowledgement signal A1 to the passive infrared sensor 4. The humidity sensor 7 retransmits the humidity information signal P2 by using the next frame F1.

In the present modification, if a user continuously operates the operation switch 3 or the passive infrared sensor 4 continuously senses presence of a human being, the possibility of overlapping between the transmission timing of the operation information signal O1 or the human sensing information signal E1 and the transmission timing of the acknowledgement signal from the receiver 2 increases. However, since the operation information signal O1 and the human sensing information signal E1 are transmitted in preference to the acknowledgement signal, collision with these information signals can be avoided. Moreover, responsiveness to the operation on the operation switch 3 and the human sensing by the passive infrared sensor 4 can be enhanced.

### Second Modification of First Embodiment

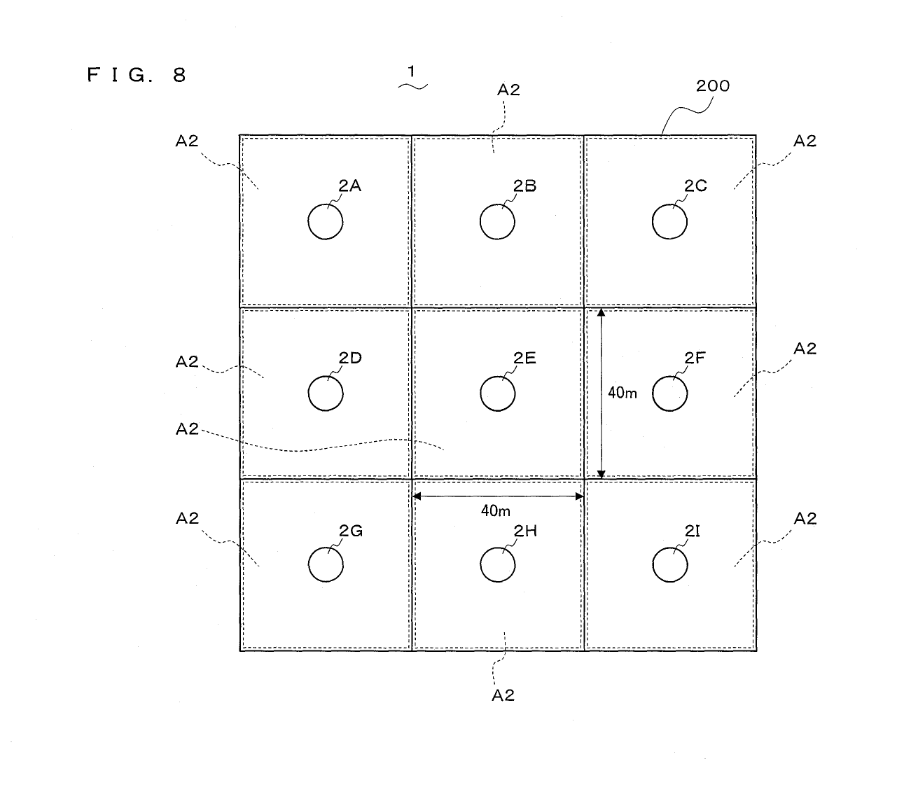

FIG. 8 shows an example of a construction of a wireless communication system according to a second modification. The wireless communication system 1 includes a plurality of receivers 2A to 2I (hereinafter referred to as receiver 2A and the like) each having the same configuration as the receiver 2 of the above embodiment. The receiver 2A and the like are installed on a floor 200 of a building. For example, the floor 200 is divided into 9 zones in matrix, and one receiver is installed in each of the 9 zones.

By the way, assuming that, in each of the receiver 2A and the like, a frequency band of a communication wave is 426 [MHz] and a communication speed is 10600 [bps], there are only four channels that can be used for telecontrol and telemeter. In the case of the above arrangement, the number of the receiver 2A and the like is greater than the number of the channels, and therefore, the channels of the transmission wave to be used by the receiver 2A and the like cannot be made different from each other. Accordingly, the receiver 2A and the like have to share the channels of the communication wave. If receivers are also installed on another floor, different channels are used between the different floors.

When the receiver 2A and the like are constructed, even if an actual arrival range of a transmission signal from each of the receiver 2A and the like is an area having a radius of 30 m or less from the receiver in the center, an allowance is provided to avoid failure of arrival. That is, assuming that the arrival range of the transmission signal (hereinafter simply referred to as a signal arrival range) A2 is, for example, about 40 m×40 m, the receiver 2A and the like are arranged so that the signal arrival ranges A2 thereof do not overlap with each other. However, even when the receiver 2A and the like are arranged as described above, if the receiver 2A and the like are spread over the floor as shown in FIG. 8, signal transmission timings might overlap with each other among the receiver 2A and the like. Then, if the information signals are simultaneously transmitted from the receiver 2A and the like, collision of the signals might actually occur. In the present modification, even if such overlapping of transmission timings occurs in the same channel, communication control that enables accurate communication is performed.

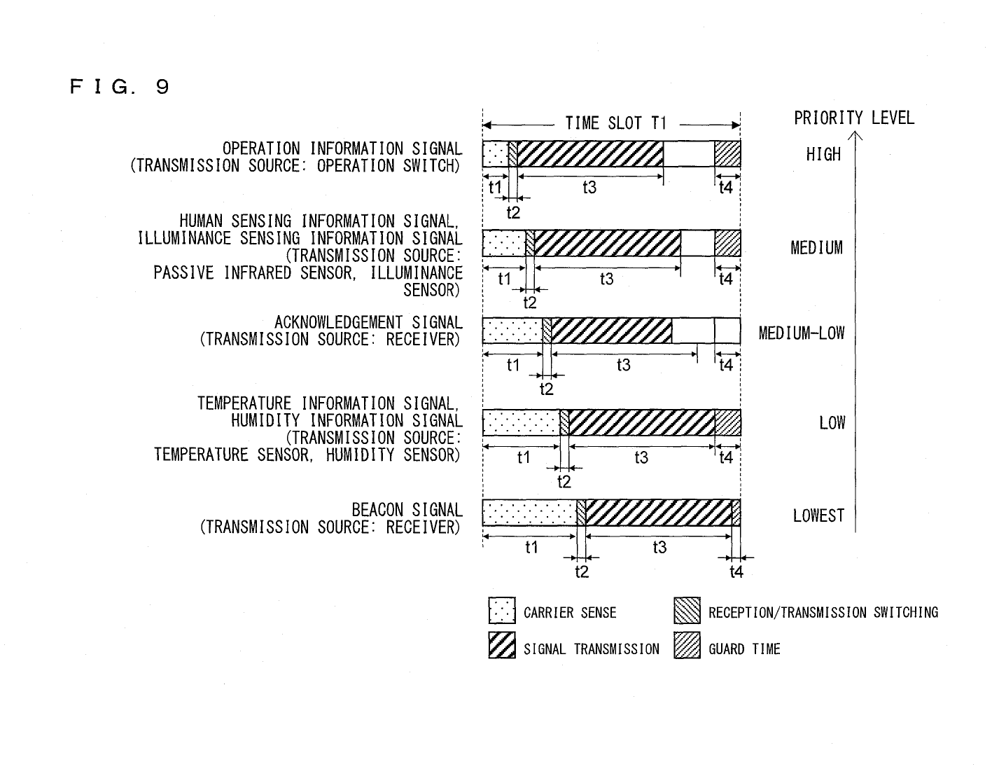

FIG. 9 shows a control process at the time of transmitting a beacon signal from each of the receiver 2A and the like according to the present modification. This process is combined with the communication process of the above first modification. In the present modification, each of the receiver 2A and the like performs, in advance of transmitting a beacon signal, carrier sense to confirm whether any other unit is transmitting an information signal, and performs reception/transmission switching, upon confirming that no other unit is transmitting an information signal. Thereafter, the receiver 2 transmits a beacon signal. This series of operations are performed within one time slot T1. There is a spare time left between the signal transmission and the end of the time slot T1, and a guard time t4 having no signal is provided in this spare time.

A priority level has previously been set in the beacon signal. The higher the priority level of the beacon signal is, the shorter the carrier sense period t1 before transmission of the beacon signal is set by the receiver 2. The priority level of the beacon signal is set to be lower than that of the temperature information signal and the humidity information signal. That is, the priority level of the beacon signal is the lowest among the priority levels of the various signals. Accordingly, the carrier sense period t1 before transmission of the beacon signal is the longest among the carrier sense periods t1 before transmission of the various signals. The carrier sense period t1 before transmission of the beacon signal partially overlap with the signal transmission periods t3 of the various information signals.

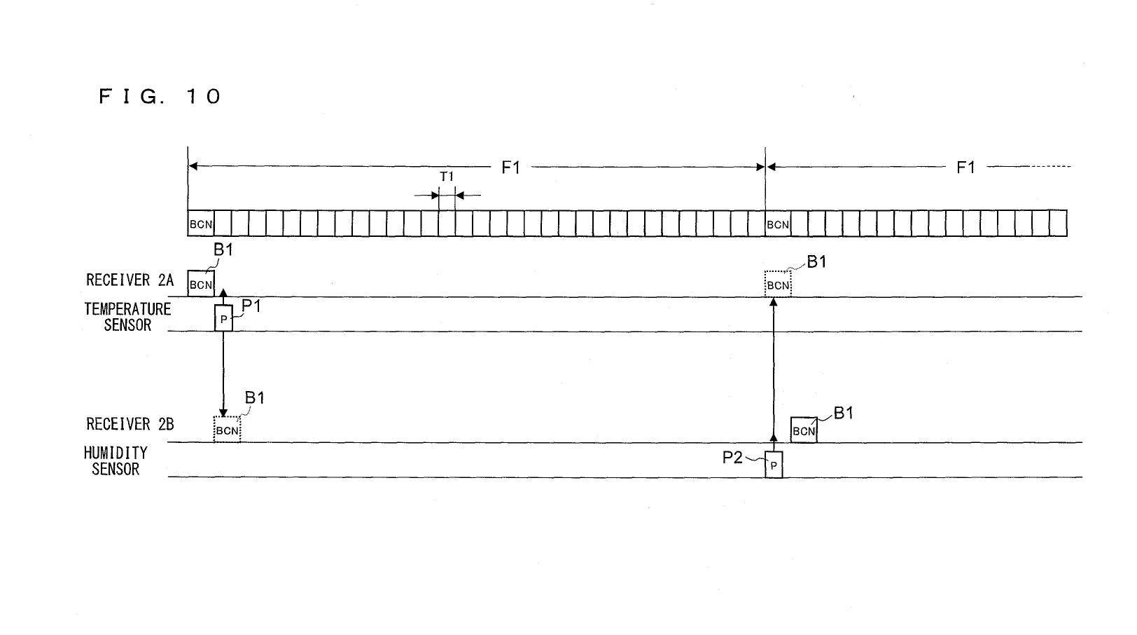

FIG. 10 shows a communication operation between the adjacent receivers 2A and 2B. In FIG. 10, the vacant period T2 is not shown. Since the communication operation between adjacent receivers among the receiver 2A and the like is common, the communication operation between the receivers 2A and 2B will be described as a representative communication operation. Transmission timings of beacon signals B1 from the adjacent receivers 2A and 2B have previously been set so as to be different from each other.

It is now assumed that transmission timing of the temperature information signal P1 or the humidity information signal P2 to the receiver 2A overlaps with transmission timing of the beacon signal B1 by the receiver 2B. The beacon signal B1 is transmitted once every frame F1 (once every second), and each of the temperature information signal P1 and the humidity information signal P2 is transmitted, for example, once every 60 frames (60 seconds) by using a fixed time slot. Therefore, in the above case, overlapping of transmission timings occurs again. However, the receiver 2B that has attempted to transmit the beacon signal B1 senses the overlapping by carrier sense, and puts off transmission of the beacon signal B1 in the frame. Thereby, transmission of the temperature information signal P1 or the humidity information signal P2 is prioritized, and the temperature sensor 6 or the humidity sensor 7 transmits the temperature information signal P1 or the humidity information signal P2 to the receiver 2A.

By the way, while the transmission cycle of the beacon signal B1 is 1 sec, the transmission cycle of each of the temperature information signal P1 and the humidity information signal P2 is 60 sec. In the wireless communication system 1 (SIC: correctively it should be receiver 2) in the center of FIG. 8, even if transmission timing of the beacon signal B1 overlaps with transmission timings of either the temperature information signal P1 or the humidity information signal P2 to all the adjacent wireless communication systems 1 (SIC: correctively it should be receivers 2), the number of times the beacon signal B1 cannot be transmitted is about 8 out of 60.

In the present modification, the receivers 2A to 2I are arranged adjacent to each other, and the receivers 2A to 2I use the same channel. In addition, it is assumed that, among the receivers 2A to 2I, periodical transmission timing of the beacon signal from one receiver overlaps with periodical transmission timing of the temperature information signal P1 or the humidity information signal P2 to another receiver. Even in such a case, in the present modification, transmission of the temperature information signal P1 or the humidity information signal P2 can be prioritized, and therefore, the beacon signal is prevented from continuously colliding with the temperature information signal P1 or the humidity information signal P2, thereby enhancing the communication accuracy. Further, even if transmission of the temperature information signal P1 or the humidity information signal P2 is prioritized, since the transmission cycle of the beacon signal is shorter than that of the physical quantity information signal, the beacon signal can be transmitted at another timing that does not overlap with the transmission timing of the temperature information signal P1 or the humidity information signal P2. Therefore, influence on the communication can be reduced.

### Third Modification of First Embodiment

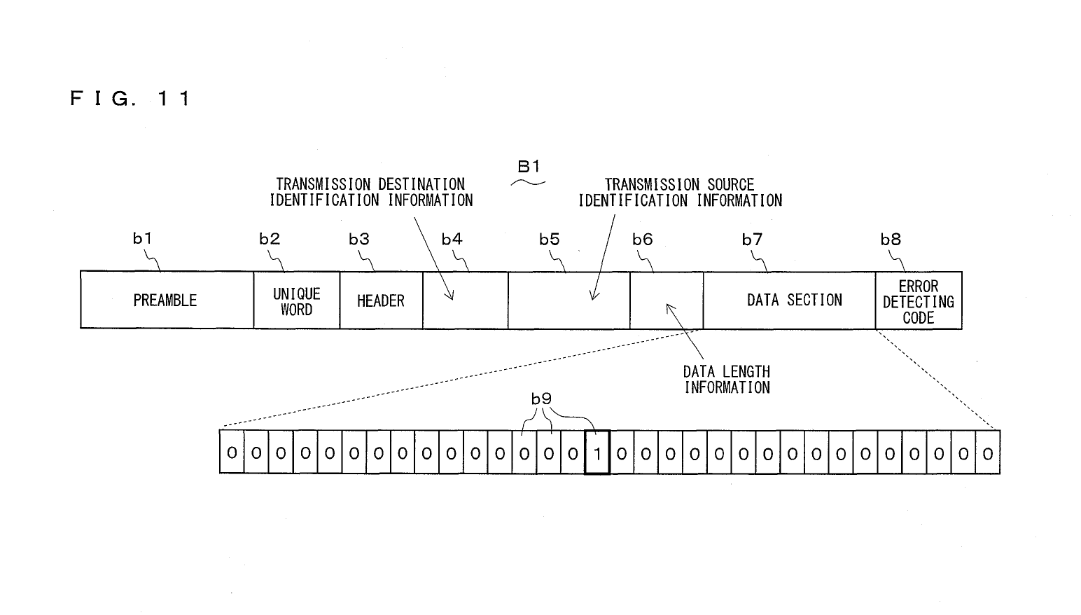

FIG. 11 shows a frame structure of a beacon signal B1 of a wireless communication system 1 according to a third modification. The “frame” described here is different from the above-mentioned frame F1, and indicates a fundamental unit of a transmission signal. The beacon signal B1 is composed of a preamble b1, a unique word b2, a header b3, transmission destination identification information b4, transmission source identification information b5, data length information b6, a data section b7, and an error detecting code b8. These components are contained in one packet, and transmitted in this order.

The preamble b1 allows a unit that receives the signal to establish bit synchronization with the signal. The preamble b1 is composed of a signal alternately repeating 1 and 0. The unit that receives the signal samples the signal at a plurality of sampling timings for one bit, and reads sign inversion timing, i.e., zero cross timing of the preamble b1. Then, the unit that receives the signal obtains sampling timing that enables accurate detection of a bit, based on the read zero cross timing, and sets the sampling timing as bit synchronization timing. For example, sampling timing closest to the middle between a zero cross point and a next zero cross point is set as bit synchronization timing. The unique word b2 allows the unit that receives the signal to identify the beginning of effective information starting from the header b3 in the frame. The unique word b2 is a signal for establishing frame synchronization.

The header b3 is MAC layer control information such as packet type information. The transmission destination identification information b4 is composed of information indicating broadcast, and is represented by 0xFF in hexadecimal format, for example. The transmission source identification information b5 is inherent identification information of a receiver 2. The data length information b6 represents the number of bytes of the data section b7. The data section b7 is a payload section of the beacon signal B1. The data section b7 contains an acknowledgement signal that notifies the temperature sensor 6 of completion of reception of a temperature information signal.

The data section b7 is composed of a bit sequence having a number of bits equal to the number of time slots per frame. Each of bits b9 in this bit sequence is associated with each of the time slots in order of the numbers of the time slots. In the bit sequence, when a temperature information signal is received, a bit b9 associated with a time slot in which the temperature information signal is received is assigned with a code of 1 while other bits b9 are assigned with a code of 0. The codes of 1 and 0 may be inverted. The error detecting code b8 is a code generated by a specific algorithm from a bit sequence from the header b3 to the data section b7, for example, and is composed of a CRC (Cyclic Redundancy Check) code or the like.

Next, a communication operation of the wireless communication system 1 according to the present modification will be described. Upon receiving a temperature information signal from the temperature sensor 6, the receiver 2 includes, in a beacon signal B1 to be transmitted next, an acknowledgement signal that notifies the temperature sensor 6 of completion of reception of the temperature information signal, and transmits the beacon signal B1 to the temperature sensor 6. Upon receiving the beacon signal B1, the temperature sensor 6 detects a bit b9 whose code is 1 from the data section b7 in the beacon signal B1. Further, the temperature sensor 6 determines whether the time slot associated with the detected bit b9 coincides with the fixed time slot assigned to the temperature sensor 6. When the time slots coincide with each other, the temperature sensor 6 regards that the acknowledgement signal is received. When there is no acknowledgement signal to be transmitted to the temperature sensor 6, the receiver 2 suspends transmission of a beacon signal to be transmitted next.

By the way, if the temperature sensor 6 is a battery-driven sensor, the power of the temperature sensor 6 is temporarily turned off for battery change and then turned on. In this case, synchronization with the time slot needs to be reestablished. Therefore, when the power of the temperature sensor 6 is turned on, the temperature sensor 6 automatically transmits a request signal that requests the receiver 2 to transmit a beacon signal B1. When the receiver 2 plans to suspend transmission of a next beacon signal, if the receiver 2 receives the request signal transmitted from the temperature sensor 6, the receiver 2 changes the plan and transmits the next beacon signal B1. The receiver 2 again performs establishment of synchronization by using the beacon signal B1.

In the present modification, since the traffic of the acknowledgement signal in response to the temperature information signal is reduced, collision of signals is reduced, thereby enhancing the communication accuracy.

Further, when there is no acknowledgement signal to be transmitted to the temperature sensor 6, transmission of a beacon signal B1 to be transmitted next is suspended, and thereby the traffic of the beacon signal B1 is reduced. Therefore, when a plurality of receivers are arranged adjacent to each other and these receivers share the same channel, even if periodical transmission timings of beacon signals B1 from the adjacent receivers overlap with each other, it is possible to reduce collision of the beacon signals B1. Accordingly, the communication accuracy can be enhanced.

Furthermore, when the temperature sensor 6 becomes asynchronous with the time slot due to battery change, the request signal is automatically transmitted from the temperature sensor 6 to the receiver 2 after battery change. Then, if the receiver 2 plans to suspend transmission of a next beacon signal B1, the receiver 2 changes the plan in accordance with the request signal, and transmits the next beacon signal. Accordingly, the temperature sensor 6 need not wait for the beacon signal B1 until the receiver 2 autonomously transmits the beacon signal B1, and synchronization can be quickly established.

Hereinafter, reference examples relating to the above first embodiment will be described with reference to the drawings. The configuration of a wireless communication system of each reference example is identical to that of the first embodiment, and therefore, will be described with reference to FIG. 1 again. In addition, in the drawings of each reference example, the same components as in the first embodiment are denoted by the same reference numerals.

### First Reference Example of First Embodiment

FIG. 12 shows a communication setting and a communication operation of a wireless communication system according to a first reference example. In a time slot T1 of the present reference example, a preferential slot T3 (preferential time slot) is periodically set, in which only information signals of high priority levels among the various information signals are transmitted. In the preferential slot T3, only information signals of priority levels equal to or higher than a predetermined priority level, specifically, equal to or higher than the medium level (the operation information signal, the human sensing information signal) are transmitted. For example, the preferential slot T3 is set at every other time slot, and other time slots T1 are set as general slots T4 in which any of the various information signals can be transmitted. Thereby, the preferential slots T3 and the general slots T4 are alternately arranged.

Communication operations of the operation switch 3A and the like according to the present reference example will be described with reference to numerals in parentheses in FIG. 12. Among the operation switch 3A and the like, wireless slave units that transmit information signals of the same priority level perform similar communication operations. Therefore, the communication operation of one of these wireless slave units will be described as a representative communication operation. For example, between the passive infrared sensor 4 and the illuminance sensor 5, only the passive infrared sensor 4 will be described.

(9) The operation switch 3A may use either of a preferential slot T3 or a general slot T4 to transmit the operation information signal O1. The same applies to the case where the passive infrared sensor 4 transmits the human sensing information signal E1.

(10) Upon receiving the operation information signal O1 from the operation switch 3A, the receiver 2 transmits, by using a preferential slot T3, an acknowledgement signal A1 that notifies completion of reception of the operation information signal O1. The receiver 2 operates in a similar manner also when receiving the human sensing information signal E1 from the passive infrared sensor 4.

(11) The temperature sensor 6 and the humidity sensor 7 transmit the temperature information signal P1 and the humidity information signal P2, respectively, by using only general slots T4. The temperature sensor 6 and the humidity sensor 7 periodically transmit the temperature information signal P1 and the humidity information signal P2, for example, once every 60 frames F1, i.e., once every 60 seconds, by using fixed general slots T4 that have previously been assigned to the sensors 6 and 7, respectively. The general slot T4 assigned to the temperature sensor 6 and the general slot T4 assigned to the humidity sensor 7 are different from each other.

(12) The humidity sensor 7 is set so as to transmits the humidity information signal P2, for example, once every 60 frames, by using a fixed general slot T4 that has previously been assigned to the sensor 7. Therefore, even when the humidity sensor 7 becomes ready for transmitting the humidity information signal P2 by using a preferential slot T3, the humidity sensor 7 puts off transmission until a next general slot T4 comes, and transmits the humidity information signal P2 by using the general slot T4. The temperature sensor 6 performs a similar transmission process. The temperature sensor 6 and the humidity sensor 7 periodically transmit the temperature information signal P1 and the humidity information signal P2, for example, once every 60 frames F1, i.e., once every 60 seconds, by using fixed general slots T4 that have previously been assigned to the sensors 6 and 7, respectively. The general slot T4 assigned to the temperature sensor 6 and the general slot T4 assigned to the humidity sensor 7 are different from each other.

(13) If the passive infrared sensor 4 and the temperature sensor 6 transmit the human sensing information signal E1 and the temperature information signal P1, respectively, by using the same general slot T4, collision of the information signals occurs. The passive infrared sensor 4 detects that an acknowledgement signal A1 that should be returned from the receiver 2 is not received within a predetermined time period, and thereby senses the collision based on the detection result. Upon sensing the collision, the passive infrared sensor 4 retransmits the human sensing information signal by using a preferential slot T3. The preferential slot T3 in which the human sensing information signal is retransmitted may be determined at random among the preferential slots T3, or may be a preferential slot T3 after a predetermined time has passed from the collision sensing. If operation information signals O1 collide with each other or an operation information signal O1 and another information signal collide with each other, the operation switch 3 performs a process similar to that performed by the passive infrared sensor 4.

In the present reference example, when the operation switch 3A and the like attempt to transit information signals of different priority levels by using the same time slot T1, if the time slot T1 is a preferential slot T3, only the wireless slave unit that attempts to transmit the information of higher priority level is allowed to transmit the information signal. Accordingly, by allowing the wireless slave unit to transmit the information signal, only the information of higher priority level is transmitted. As a result, transmission of the information signal of higher priority level can be prioritized with reliability.

Further, since the preferential slot T3 is set at every other time slot T1, the operation switch 3, the passive infrared sensor 4, and the illuminance sensor 5 can preferentially transmit the operation information signal O1, the human sensing information signal E1, and the illuminance sensing information signal, respectively, after waiting for only one time slot T1 at most.

### Second Reference Example of First Embodiment

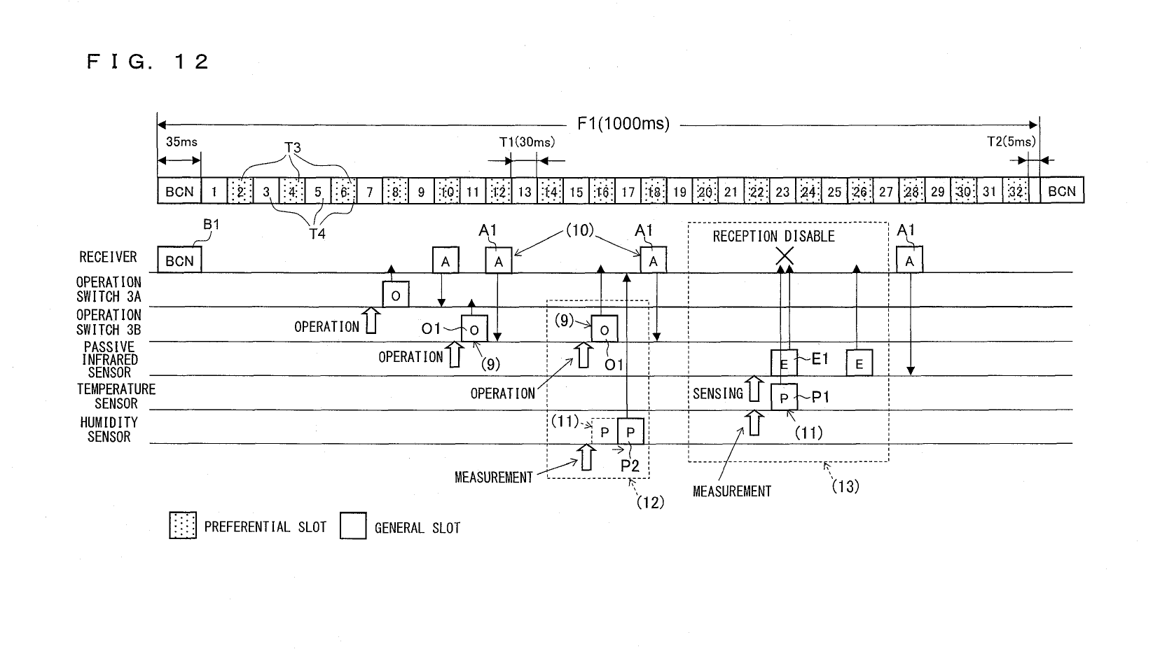

FIG. 13 shows configurations of a receiver 2 and operation switch 3A and the like of a wireless communication system 1 according to a second reference example. When the control microcomputer 23 (receiver 2), which is receiving an information signal from any one of the operation switch 3A and the like, receives an information signal from another one of the operation switch 3A and the like, if the transmission power of the latter information signal is higher than that of the former information signal, the control microcomputer 23 regards the former information signal as a noise component. Accordingly, the control microcomputer 23 preferentially receives the latter information signal by performing a filtering process or the like. If the transmission power of the latter information signal is lower than that of the former information signal, the control microcomputer 23 preferentially continues reception of the former information signal, and regards the latter information signal as a noise component.

Control microcomputer 33 and the like (operation switch 3A and the like) include transmission power control circuits 33a, 43a, 53a, 63a, and 73a (hereinafter referred to as transmission power control circuit 33a and the like) for controlling the transmission powers of the wireless transmission/reception circuit 32 and the like, respectively.

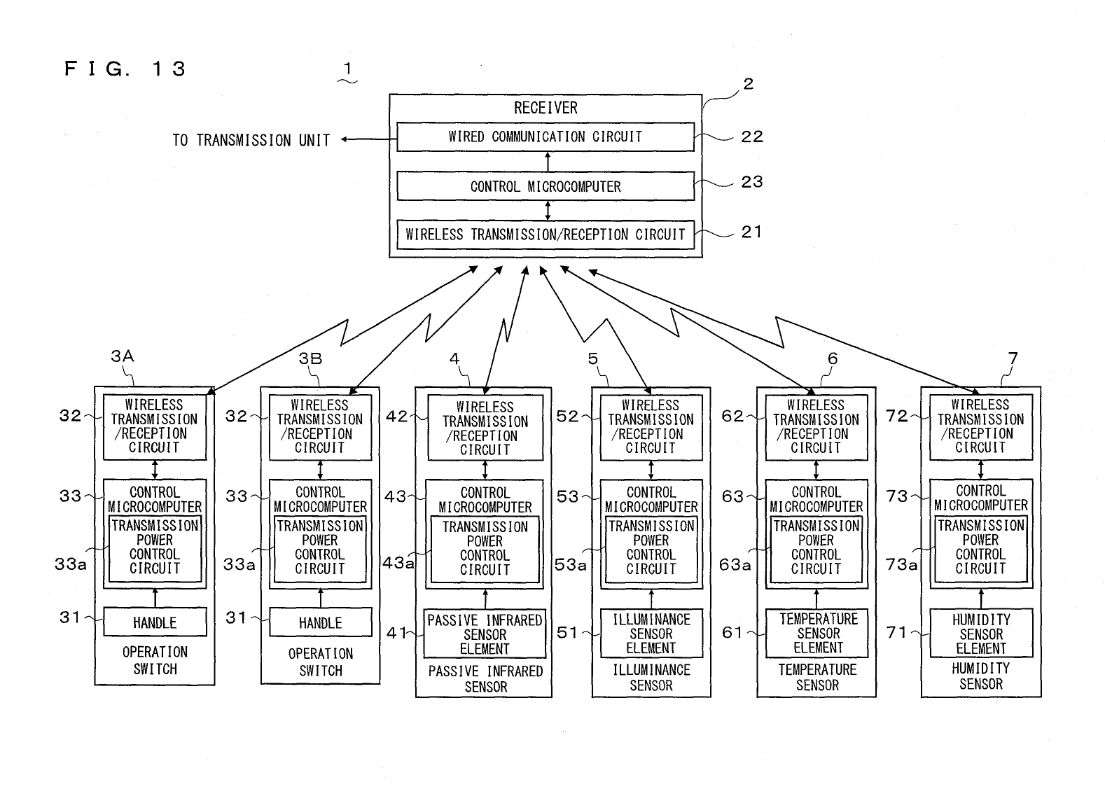

Next, a communication operation of the wireless communication system of the present reference example will be described with reference to FIG. 14 as well as FIG. 13. Although control of transmission powers in the wireless communication system 1 is actually performed by the control microcomputer 33 and the like, hereinafter, for convenience of description, the operation switch 3A and the like will be described as major units for communication. FIG. 14 shows the relationship between the priority levels of the various signals and the transmission powers thereof in the wireless communication system of the present reference example. The higher the priority levels of the information signals to be transmitted from the operation switch 3A and the like are, the higher the transmission powers of the information signals are set. The transmission powers have previously been determined in stages according to the priority levels.

If the transmission periods of information signals of different priority levels overlap with each other, the transmission powers of the information signals are different from each other, and the receiver 2 preferentially receives the information signal of higher transmission power. Since the information signal of higher priority level has higher transmission power, the receiver 2 preferentially receives the information signal of higher priority level. It is now assumed that the information signals whose transmission periods overlap with each other are the operation information signal and either of the human sensing information signal or the illuminance sensing information signal. In this case, the reception of the operation information signal is prioritized, while the other information signal is not received. Then, either the passive infrared sensor 4 or the illuminance sensor 5 which has transmitted the information signal does not receive, within a predetermined period, an acknowledgement signal that the sensor 4 or 5 should receive from the receiver 2, and thereby senses transmission failure. Either the passive infrared sensor 4 or the illuminance sensor 5 which has failed in transmission retransmits the information signal in a random period or after a predetermined period has passed.

On the other hand, if the transmission periods of information signals of the same priority level overlap with each other, specifically, if the transmission periods of the human sensing information signal and the illuminance sensing information signal overlap with each other, the passive infrared sensor 4 and the illuminance sensor 5 sense that an acknowledgement signal which should be returned from the receiver 2 is not received within a predetermined period. Then, the passive infrared sensor 4 and the illuminance sensor 5, based on the sensing result, recognize transmission failure. The passive infrared sensor 4 and the illuminance sensor 5 retransmit the information signals in random periods or after predetermined periods different from each other have passed, respectively.

In the present reference example, even when the transmission periods of a plurality of information signals of different priority levels overlap with each other among the operation switch 3A and the like, the transmission power of the information signal of higher priority level increases, while the transmission power of the information signal of lower priority level decreases. Accordingly, even if radio waves interfere with each other and a plurality of information signals overlap with each other, an information signal of lower transmission power is regarded as a noise component with respect to an information signal of higher transmission power, and therefore, can be removed by a filtering process or the like in the receiver 2. As a result, it is possible to cause the receiver 2 to receive the information signal of higher transmission power, and thus it is possible to reliably prioritize transmission of the information signal of higher priority level. Moreover, in order to prioritize transmission of the information signal of higher priority level, management of transmission timing performed in the conventional system is not necessary, and it is only necessary to set the transmission power to be higher. As a result, the configuration including software is simplified.

### Second Embodiment

Hereinafter, an equipment control system including a wireless communication system according to a second embodiment of the present invention will be described with reference to the drawings. The configuration of the equipment control system is identical to that shown in FIG. 1, and therefore, will be described with reference to FIG. 1 again. In addition, in the drawings of the second embodiment, the same components as in the first embodiment are denoted by the same reference numerals.

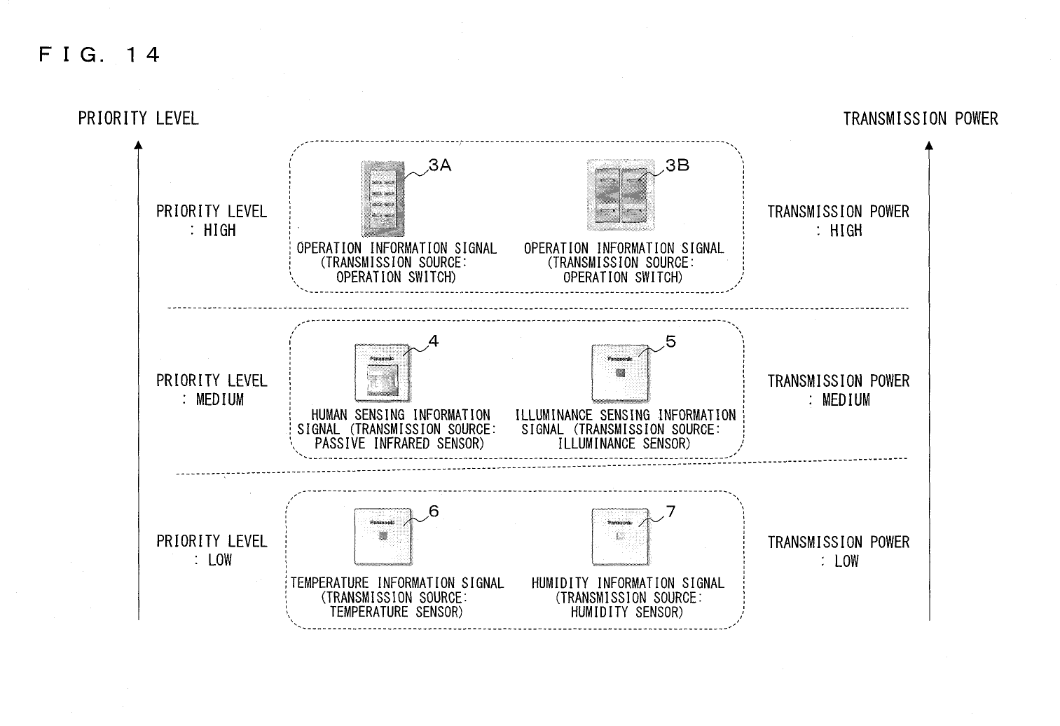

FIG. 15 shows the configuration of the wireless communication system 1 according to the present embodiment. In the present embodiment, the wireless communication system 1 includes an operation switch 3 having a configuration similar to that of each operation switch 3A, 3B of the first embodiment. However, the number of the operation switches is not limited thereto. In addition, the wireless communication system 1 includes, instead of the temperature sensor 6 and the humidity sensor 7 of the first embodiment, a temperature/humidity sensor 8 obtained by integrating the temperature sensor 6 and the humidity sensor 7. However, the temperature sensor 6 and the illuminance sensor 7 may be provided.

The operation switch 3 further includes an operation clock oscillator 34 and a battery 35. The passive infrared sensor 4 further includes an operation clock oscillator 44 and a battery 45. The illuminance sensor 5 further includes an operation clock oscillator 54 and a battery 55. In the illuminance sensor 5, the illuminance sensor element 51 periodically senses illuminance in the environmental atmosphere, and the wireless transmission/reception circuit 52 wirelessly transmits, to the receiver 2, an illuminance information signal indicating the illuminance sensed by the illuminance sensor element 51.

The temperature/humidity sensor 8 includes: a temperature/humidity sensor element 81 that periodically senses temperature and humidity in the environmental atmosphere; and a wireless transmission/reception circuit 82 that wirelessly transmits, to the receiver 2, a temperature/humidity information signal indicating the temperature and humidity sensed by the temperature/humidity sensor element 81. Further, the temperature/humidity sensor 8 includes a control microcomputer 83, an operation clock oscillator 84, and a battery 85.

Hereinafter, the operation switch 3, the passive infrared sensor 4, the illuminance sensor 5, and the temperature/humidity sensor 8 are referred to as “operation switch 3 and the like”, the wireless transmission/reception circuits 32, 42, 52, and 82 are referred to as “wireless transmission/reception circuit 82 (SIC: correctly it should be 32) and the like”, and the control microcomputers 33, 43, 53, and 83 are referred to as “control microcomputer 33 and the like”. Further, the operation clock oscillators 34, 44, 54, and 84 are referred to as “operation clock oscillator 34 and the like”, and the batteries 35, 45, 55, and 85 are referred to as “battery 35 and the like”.

The slotted ALOHA scheme is adopted as a communication method between the receiver 2 and the operation switch 3 and the like. The wireless transmission/reception circuit 21 periodically wirelessly transmits a beacon signal that defines time slots. The wireless transmission/reception circuit 32 and the like receive the beacon signal periodically wirelessly transmitted from the wireless transmission/reception circuit 21, and wirelessly transmit various information signals to the receiver 2 in synchronization with the time slots defined by the beacon signal. The wireless transmission/reception circuit 21 also transmits various signals to the wireless transmission/reception circuit 32 and the like in synchronization with the time slots defined by the beacon signal transmitted from the wireless transmission/reception circuit 21.

The control microcomputer 33 and the like perform communication control for the wireless transmission/reception circuit 32 and the like, respectively. The operation clock oscillator 34 and the like are each composed of a quartz resonator or the like, and generate operation clock signals for the control microcomputer 33 and the like, respectively. The operation switch 3 and the like are driven by the battery 35 and the like, respectively.

Next, a specific configuration for wireless communication in the operation switch 3 will be representatively described among the operation switch 3 and the like. The specific configuration is common to the operation switch 3 and the like, and therefore, description of specific configurations of the wireless slave units other than the operation switch 3 will be omitted (The same applies to modifications described later).

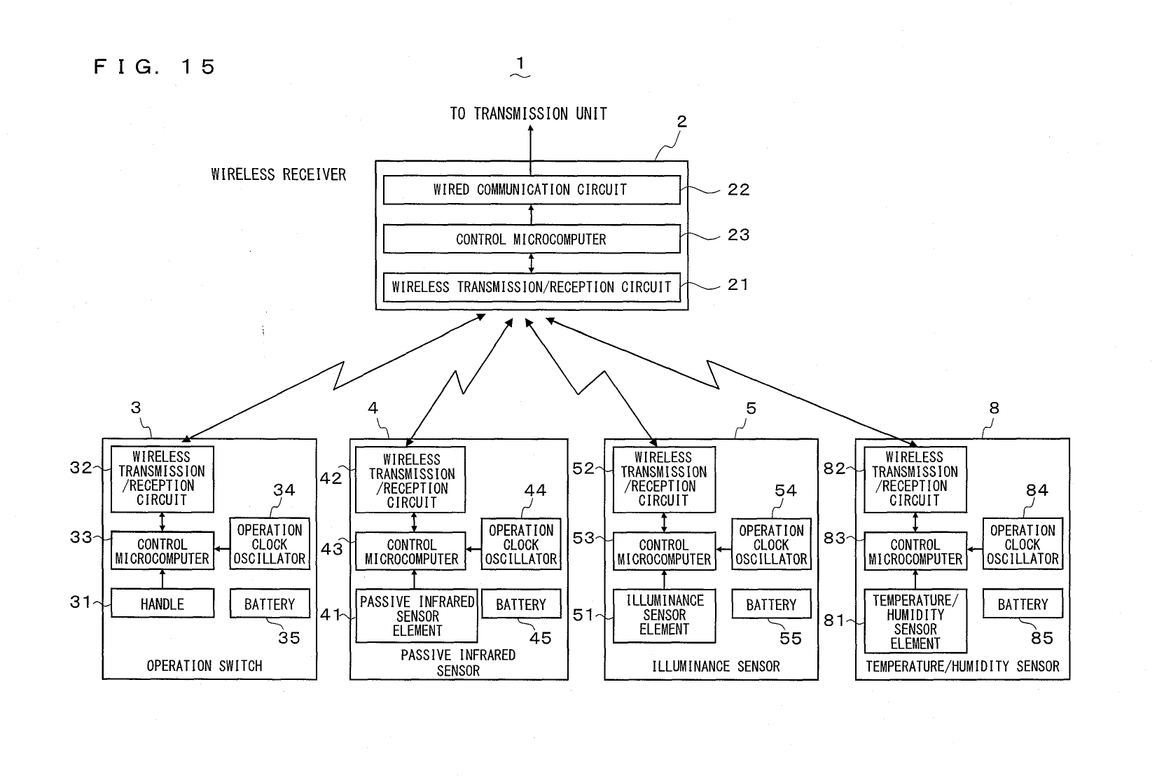

FIGS. 16(a) and (b) show the specific configuration of the operation switch 3. In FIG. 16(a), illustration of the battery 35 (refer to FIG. 15) is omitted. As shown in FIG. 16(a), the wireless transmission/reception circuit 32 includes: a wireless communication oscillator 32a that generates a wireless communication clock signal for determining a carrier frequency of a signal to be transmitted; a modulation circuit 32b that modulates the signal to be transmitted; and a demodulation circuit 32c that demodulates a received signal. The wireless transmission/reception circuit 32 may be composed of an LSI for wireless communication or the like, and is connected to an antenna 36.

The wireless communication oscillator 32a includes: a quartz resonator 32d; and a PLL synthesizer 32e that frequency-divides a clock signal outputted from the quartz resonator 32d, and outputs the frequency-divided clock signal as a wireless communication clock signal. The frequency of the wireless communication clock signal is, for example, about several tens [MHz], and is higher than the frequency of the operation clock signal.

The modulation circuit 32b, by using the wireless communication clock signal outputted from the wireless communication oscillator 32a, up-converts the frequency of the modulated signal to a carrier frequency determined by the wireless communication clock signal. The up-converted signal is wirelessly transmitted via the antenna 36. Since the carrier frequency is common to the receiver 2 and the operation switch 3 and the like, the demodulation circuit 32c down-converts the reception signal received via the antenna 36 by using the wireless communication clock signal, and demodulates the down-converted signal, thereby restoring the original signal.

As shown in FIG. 16(b), the control microcomputer 33 includes: an oscillation circuit 33b that oscillates the operation clock oscillator 34; and a timer 33c that counts time based on the operation clock signal generated from the operation clock oscillator 34 in its oscillating state. Further, the control microcomputer 33 includes: a core unit 33d; and a memory 33x (memory circuit) in which an operation program for the core unit 33d is stored. The memory 33x has stored therein a time slot definition program 33e for defining time slots by using the timer 33c. The core unit 33d operates in accordance with the time slot definition program 33e, and functions as a time slot definition circuit. Further, the core unit 33d detects, from signals demodulated by the demodulation circuit 32c, a beacon signal which is a reference for defining time slots.

The timer 33c counts time by counting the number of clocks of the operation clock signal, and detects that a unit time has elapsed every time a reference number of clocks, which has previously been set, have been counted.

The core unit 33d, based on the detection of the beacon signal, judges the timing of reception of the beacon signal by the wireless transmission/reception circuit 32, and defines time slots by using the timer 33c, starting from the reception timing. The time length of each time slot has previously been set, and is common to the receiver 2 and the operation switch 3 and the like. The memory 33x may be implemented by a nonvolatile memory such as an EEPROM.

By the way, generally, an operation clock oscillator used for operation of a microcomputer has an oscillation frequency (frequency of an operation clock signal) whose accuracy and precision are not very high. Accordingly, if time is counted by a timer based on only the operation clock signal and time slots are defined based on the count time value, the time slots might be advanced or delayed due to a count time error, which might cause a lag in communication timing with another equipment, and eventually, failure in establishment of communication with the another equipment.

Therefore, in order to correct the count time value of the timer 33c, the control microcomputer 33 further includes a correction timer 33f. Further, a count time value correction program 33g is stored in the memory 33x. The core unit 33d operates in accordance with the count time value correction program 33g, and functions as a count time value correction circuit.

The correction timer 33f counts time based on the wireless communication clock signal generated by the wireless communication oscillator 32a, and counts time by counting the number of clocks of the wireless communication clock signal. Generally, a wireless communication oscillator is designed to oscillate with high accuracy and high precision in accordance with the regulations of the Radio Law, and accuracy and precision of its oscillation frequency (frequency of a wireless communication clock signal) are significantly high as compared to an operation clock oscillator. Therefore, the time counted by the correction timer 33f is much more accurate and precise than the time counted by the timer 33c.

Therefore, the core unit 33d corrects the count time value of the timer 33c, based on the result of time count by the correction timer 33f. In this way, the core unit 33d corrects the above-mentioned count time value, based on the wireless communication clock signal generated from the wireless communication oscillator 32a.

A specific correction method by the core unit 33d will be described. The core unit 33d, by using the correction timer 33f, counts the number of clocks of the wireless communication clock signal per unit time counted by the timer 33c, for example, per second. Then, the core unit 33d corrects the count time value of the timer 33c, based on the counted number of clocks of the wireless communication clock signal. Specifically, the core unit 33d divides the number of clocks of the wireless communication clock signal counted in the unit time, by the number of clocks of the wireless communication clock signal which should be counted in an original unit time.

A value obtained by this division will be described. The timer 33c detects that the unit time has elapsed when the timer 33c counts the operation clock signal by a reference number of clocks. Therefore, for example, it is assumed that, if the period of the operation clock signal is reduced, the unit time counted by the timer 33c is also reduced. Then, the number-of-clocks C1 of the wireless communication clock signal counted within the unit time becomes smaller than the number-of-clocks C1′ to be counted within the original unit time. Therefore, by dividing the number-of-clocks C1 by the number-of-clocks C1′, it is possible to obtain a change rate α of the unit time due to an error.

The core unit 33d multiples an inverse of the change rate a (an inverse of the value obtained by the above division) by the current reference number of clocks of the operation clock signal, rounds off the value obtained by the multiplication, and sets the resultant value as the reference number of clocks. By this setting, the elapsed time when the operation clock signal has been counted by the reference number of clocks is more approximated to the original unit time.

The core unit 33d periodically performs the process of correcting the count time value of the timer 33c. In order to reduce power consumption, the core unit 33d sets the correction timer 33f in the drive mode only when the correction process is performed.

The core unit 33d assigns a signal to be transmitted by the wireless transmission/reception circuit 32 with inherent identification information of the operation switch 3, as transmission source identification information, and with inherent identification information of the receiver 2 as transmission destination identification information. Then, it is assumed that the transmission-destination inherent identification information assigned to the signal received by the wireless transmission/reception circuit 32 coincides with the inherent identification information of the operation switch 3, and the transmission-source inherent identification information coincides with the inherent identification information of the receiver 2 which has previously been inputted by a setter or the like. Then, the core unit 33d causes the wireless transmission/reception circuit 32 to perform down conversion and demodulation. Such a process of identifying the transmission source and the transmission destination is also performed by the control microcomputer 23 with the wireless transmission/reception circuit 21.

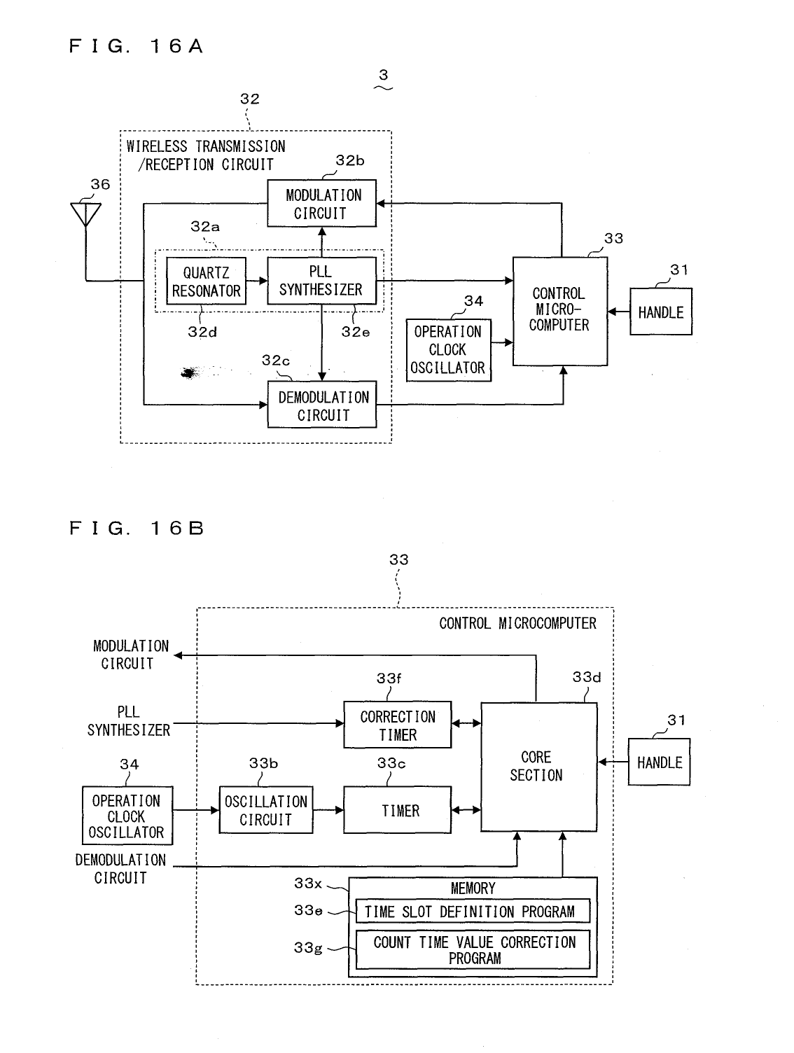

Next, a communication method and a communication operation of the wireless communication system 1 will be described with reference to FIG. 17 as well as FIGS. 13 and 14. FIG. 17 shows examples of the communication method and the communication operation of the wireless communication system 1. The communication in the wireless communication system 1 is actually performed between the wireless transmission/reception circuit 21 constituting the receiver 2 and the wireless transmission/reception circuit 32 and the like constituting the operation switch 3 and the like. However for convenience of description, the receiver 2 and the operation switch 3 and the like will be described as major units for communication.

As the communication method of the wireless communication system 1, the slotted ALOHA scheme is adopted, in which communication time is divided into frames F1 of a constant time length, each frame F1 is divided into a plurality of time slots of a constant time length, and communication is performed in units of time slots T1. The receiver 2 and the operation switch 3 and the like are synchronized with the time slots T1, and transmit signals by using arbitrary time slots T1 or previously assigned time slots T1, respectively.

The receiver 2 generates a beacon signal B1 that defines the time slots T1, and wirelessly transmits the beacon signal B1 to the operation switch 3 and the like. The operation switch 3 and the like receive the beacon signal B1. The receiver 2 and the operation switch 3 and the like define time slots T1 based on the transmitted beacon signal B1 and the received beacon signal B1, respectively, and establish synchronization with the time slots T1. The beacon signal B1 is transmitted periodically (specifically, every frame F1) in order to realize continuous and accurate synchronization establishment. The beacon signal B1 is provided at the beginning of each frame F1. In the present embodiment, a vacant period T2 of the first embodiment (refer to FIG. 4) is not provided at the end of each frame F1. However, a vacant period T2 may be provided. In addition, the number of the time slots T1 in each frame F1 is not limited to the number shown in FIG. 17.

When the handle 31 is operated, the operation switch 3 transmits an operation information signal O1 to the receiver 2 by using a time slot T1 immediately after the operation. When the passive infrared sensor element 41 senses presence of a human being, the passive infrared sensor 4 transmits a human sensing information signal E1 to the receiver 2 by using a time slot T1 immediately after the sensing.

The illuminance sensor 5 periodically transmits an illuminance information signal L1, for example, once every 60 frames F1, by using a fixed time slot T1 that has previously been assigned to the sensor 5. Also the temperature/humidity sensor 8 periodically transmits a temperature/humidity information signal P3, for example, once every 60 frames F1, by using a fixed time slot T1 that has previously been assigned to the sensor 8. The time slot T1 assigned to the illuminance sensor 5 and the time slot T1 assigned to the temperature/humidity sensor 8 are different from each other.

Upon receiving the various information signals from the operation switch 3 and the like, the receiver 2 returns an acknowledgement signal A1 to each of the operation switch 3 and the like as the transmission sources, by using a time slot T1 in which the information signal has been received. The acknowledgement signal A1 is a signal that notifies completion of reception of each information signal.

In the operation switch 3 or the like, the core unit (having the same configuration as the core unit 33d) of the control microcomputer estimates the transmission timing of the beacon signal B1 from the receiver 2. Since it is defined that the receiver 2 periodically transmits the beacon signal for every frame F1, it is possible to estimate the transmission timing of the beacon signal B1 based on the definition. Further, in order to save the battery 35 or the like, the wireless transmission/reception circuit 32 or the like is switched to the drive mode only at the estimated transmission timing and at the time slot T1 in which the wireless transmission/reception circuit 32 transmits the information signal and receives the acknowledgement signal A1 from the receiver 2. Then, the wireless transmission/reception circuit 32 or the like switched to the drive mode performs a process of receiving the beacon signal B1 and the acknowledgement signal A1. This switching is performed by the control microcomputer 33 or the like turning on supply of power from the battery 35 or the like to the wireless transmission/reception circuit 32 or the like. Further, the reception process includes a demodulation process for a signal received via the antenna. In order to further save the battery 35 or the like, the wireless transmission/reception circuit 32 or the like may be switched to the drive mode, not for every frame F1 but for every multiple frames F1 that have previously been set.

By the way, in order to receive a beacon signal B1, it is necessary to detect the timing at which the beacon signal B1 is transmitted from the receiver 2. For this purpose, when the operation switch 3 or the like is powered on, the operation switch 3 or the like performs the reception process for at least a period of one frame F1. At this time, if the receiver 2 is also in the power-on state, since the beacon signal B1 is transmitted from the receiver 2 for every frame F1, the operation switch 3 or the like can receive the beacon signal B1 at least once during the above period. Then, the operation switch 3 or the like can detect the transmission timing of the beacon signal B1 by the receiver 2. After the operation switch 3 or the like has detected the transmission timing first after the power-on, the operation switch 3 or the like estimates the transmission timing of the beacon signal B1 from the receiver 2, and becomes able to perform the reception process to receive the beacon signal B1 at the estimated transmission timing.

In the present embodiment, since the timer 33c counts time by using the operation clock signal of the control microcomputer 33, current consumption of the timer 33c can be reduced as compared to the case where time is counted by using the wireless communication clock signal whose frequency is higher than that of the operation clock signal. Further, the count time of the timer 33c is corrected by using the wireless communication clock signal. Since generally the oscillation frequency of the wireless communication oscillator generating the wireless communication clock signal is highly accurate and highly precise, the time count precision is enhanced. As a result, a shift of the time slots T1 from those of the receiver 2 can be reduced, thereby enhancing the communication accuracy.

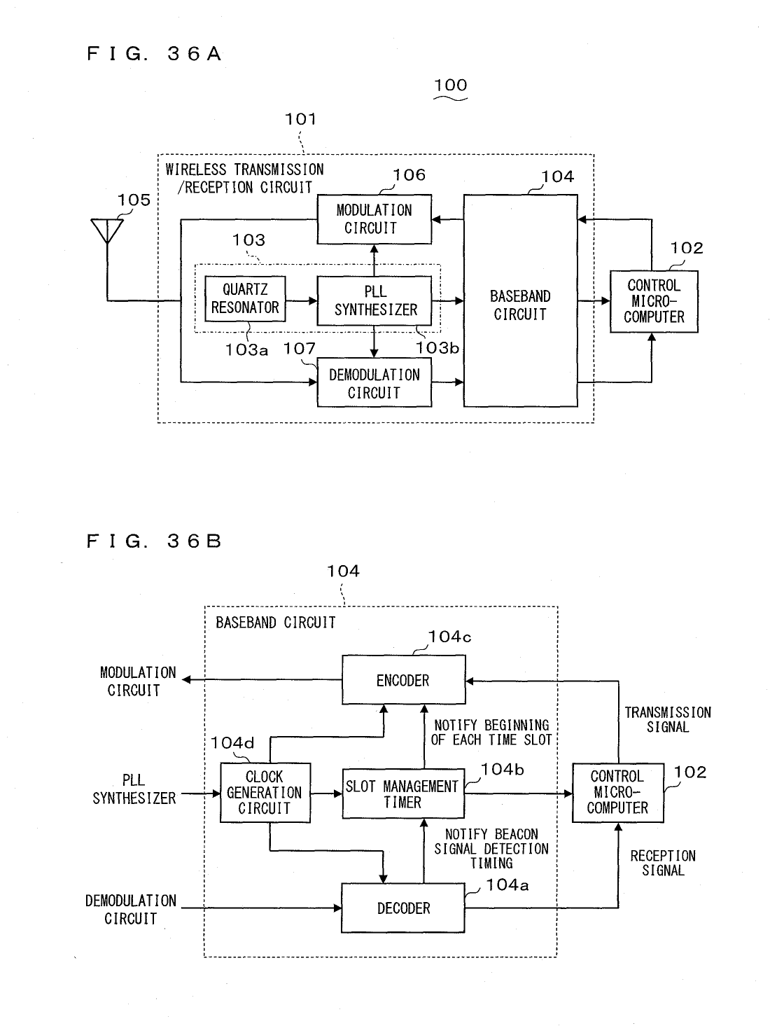

Further, the time slot definition program 33e and the count time value correction program 33g are incorporated in the control microcomputer 33. The core unit 33d performs, according to these programs, definition of time slots T1, count of the number of clocks of the operation clock signal and the wireless communication clock signal, and calculation for setting of the reference number of clocks of the operation clock signal. Therefore, it is not necessary to separately provide a gate circuit (logic circuit) dedicated for definition of time slots, a gate circuit dedicated for count, and a gate circuit dedicated for calculation. Accordingly, as compared to the wireless slave unit shown in FIGS. 36(a) and (b), the number of components can be reduced, thereby realizing reduced manufacturing cost and reduced size.

Further, although the oscillation frequency of the operation clock oscillator 34 increases or decreases depending on temperature change, the count time value of the timer 33c is periodically corrected by the core unit 33d. Therefore, even when temperature changes, an error in the count time value due to the temperature change can be reduced.

Further, since the correction timer 33f is driven only when the count time value of the timer 33c is corrected, power consumption by the correction timer 33f can be reduced. Since the correction timer 33f is driven based on the high-frequency wireless communication clock signal and therefore consumes large power, driving of the correction timer 33f only for the specific purpose greatly contributes to power saving. Further, since the wireless transmission/reception circuit 32 is also driven only for the specific purpose, power consumption by the wireless transmission/reception circuit 32 can be reduced as compared to the case where the wireless transmission/reception circuit 32 is always in the drive mode.

Since the configuration for wireless communication of the operation switch 3 is common to the passive infrared sensor 4, the illuminance sensor 5, and the temperature/humidity sensor 8, the same effects as achieved by the operation switch 3 can be achieved in these sensors (the same applies to modifications described later).

Hereinafter, wireless communication systems according to modifications of the second embodiment will be described with reference to the drawings. In the modifications, the same components as in the second embodiment are denoted by the same reference numerals. In addition, only differences of the modifications from the first embodiment (SIC: correctly it should be second embodiment) will be described.

### First Modification of Second Embodiment

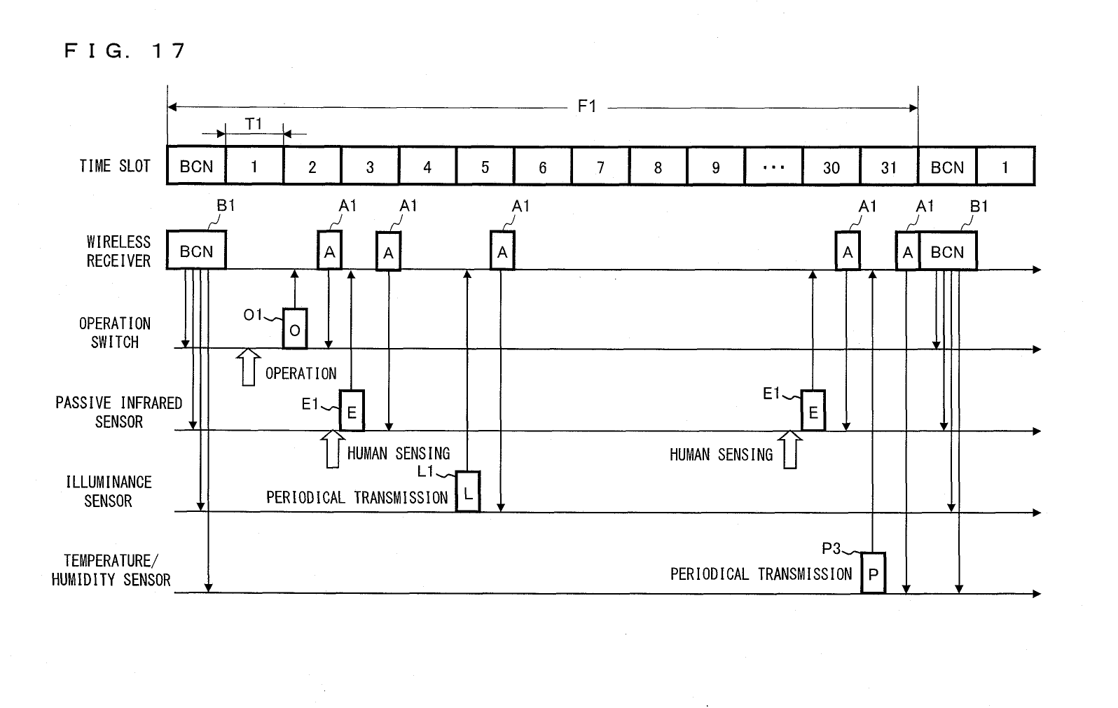

FIGS. 18(a) and (b) show the configuration of the operation switch 3 and the internal configuration of the control microcomputer of the operation switch 3, respectively, in the wireless communication system according to the first modification. In the present modification, the operation switch 3 further includes a temperature sensor element 37 that measures the temperature of the operation switch 3. A temperature compensation program 33h and a table (hereinafter referred to as correction table) 38 are stored in the memory 33x, which are used for correcting a count time error, based on the measured temperature. The core unit 33d operates in accordance with the temperature compensation program 33h, and functions as a temperature compensation circuit. The core unit 33d, having this function, causes the temperature sensor element 37 to measure the temperature with a cycle shorter than a cycle of correction, and performs a process of correcting the count time value when a change amount or a change rate of the temperature currently measured by the temperature sensor element 37 with respect to the temperature most recently measured by the temperature sensor element 37 is equal to or larger than a threshold.

The correction table 38 is a table in which temperature zones of the operation switch 3 are associated with count time errors of the timer 33c. The count time errors are each represented by the above-mentioned change rate a of the unit time. When the measured temperature is included in any of the temperature zones in the correction table, the core unit 33d corrects the count time value based on the count time error associated with the temperature zone, with reference to the correction table 38. On the other hand, when the measured temperature is included in none of the temperature zones in the correction table 38, the core unit 33d measures the count time error of the timer 33c, and adds the count time error in association with the measured temperature in the correction table 38, and corrects the count time value based on the count time error. It is preferred that the wireless slave units other than the operation switch 3 each have a configuration similar to the operation switch 3 of the present modification. Further, in the temperature/humidity sensor 8, it is desired that the temperature/humidity sensor element 81 includes a configuration similar to the temperature sensor element 37.

In the present modification, it is assumed that the change amount or the change rate of the temperature within the correction period of the core unit 33d sharply changes so as to exceed the threshold, and the count time value of the timer 33c changes due to the temperature dependence of the operation clock oscillator 34. Even in such a case, in the present modification, the core unit 33d can quickly correct the count time value without waiting for a next correction period. Accordingly, influence of the temperature change on the time count can be reduced, thereby enhancing the time count accuracy.

Furthermore, if the measured temperature by the temperature sensor element 37 is included in any of the temperature zones in the table, the core unit 33d need not measure the count time error when correcting the count time value of the timer 33c. Therefore, the number of times of measurement of the count time error can be reduced, and thus power consumption due to the measurement can be reduced.

### Second Modification of Second Embodiment

The circuit configurations of the operation switch 3 and the like in the wireless communication system according to the second modification are identical to those of the second embodiment, and therefore, will be described with reference to FIG. 15 again.

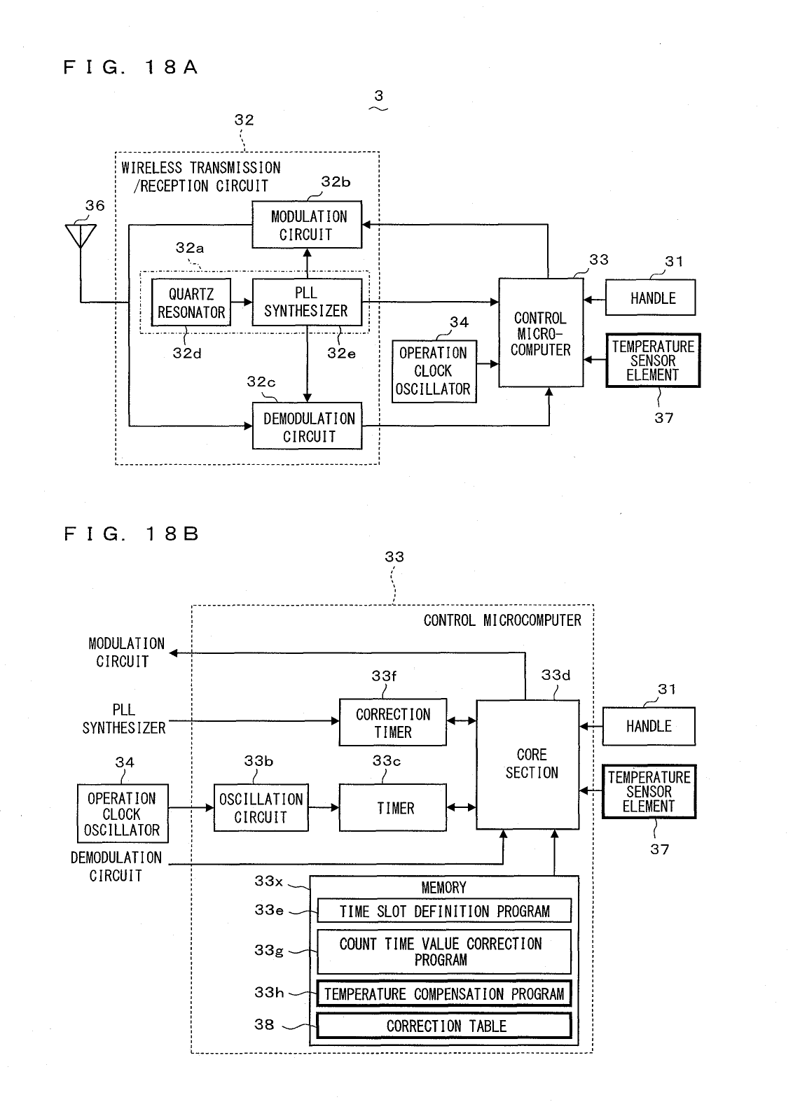

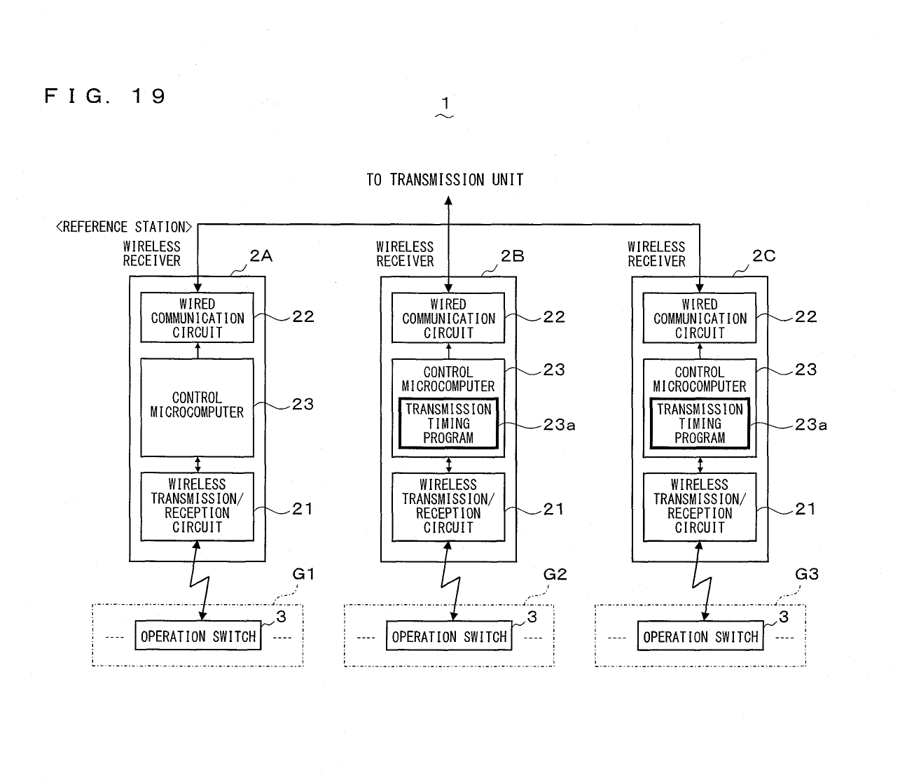

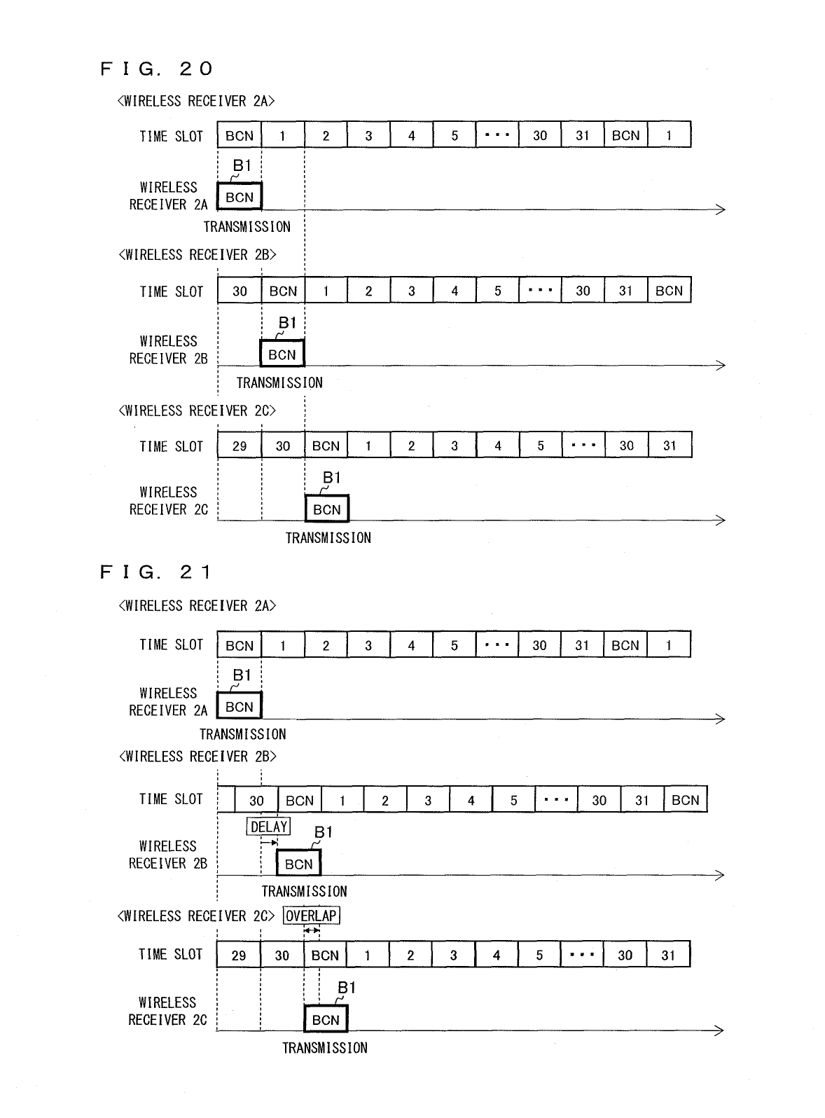

FIG. 19 shows the configuration of the wireless communication system 1 of the second modification, and FIG. 20 shows communication operations of receivers in the wireless communication system 1. The wireless communication system 1 of the present modification includes a plurality of receivers 2A, 2B, and 2C (hereinafter collectively referred to as “receiver 2A and the like”) each having a configuration similar to the receiver 2 of the second embodiment. Further, the wireless communication system 1 includes three groups G1, G2, and G3 (hereinafter collectively referred to as “group G1 and the like”) each being composed of the operation switch 3 and the like.

In the present modification, a case is assumed in which the receiver 2A and the like are installed so that the signal arrival ranges of the receiver 2A and the like do not substantially overlap with each other, and the group G1 and the like are associated with the receiver 2A and the like, respectively. The numbers of the receivers and the groups in the equipment control system 10 are not limited to those mentioned above. In addition, each of the group G1 and the like is not necessarily composed of all the operation switch 3 and the like, but may be composed of some of the operation switch 3 and the like.

The group G1 and the like receive, by using the wireless transmission/reception circuit 32 and the like (refer to FIG. 15), beacon signals wirelessly transmitted from the wireless transmission/reception circuits 21 of the associated receiver 2A and the like, respectively. The above-mentioned association is realized by installing the group G1 and the like in the signal arrival ranges of the receiver 2A and the like, and performing setting so that the receiver 2A and the like and the group G1 and the like can communicate with each other, respectively.

A transmission timing correction program 23a for correcting transmission timing of a beacon signal is incorporated in the control microcomputer 23 of the receiver 2B, 2C. The control microcomputer 23 operates in accordance with the transmission timing correction program 23a, and functions as a transmission timing control microcomputer 23. This function will be described later.

The receiver 2A and the like are configured so that transmission timings of beacon signals by the wireless transmission/reception circuits 21 do not overlap with each other. This configuration will be described in detail. Although communication between the receiver 2A and the like is performed by the wired communication circuits 22, the receiver 2A and the like will be described as major units for communication, with the wired communication circuits 22 being omitted.

One of the receiver 2A and the like has previously been configured, as a base station, to transmit a beacon signal B1 first among the receiver 2A and the like. For example, it is assumed that the receiver 2A is configured as a base station. The other receivers each include a setting operation switch (not shown) for setting a transmission order of beacon signals B1.

When wirelessly transmitting a beacon signal B1 first, the receiver 2A transmits a beacon transmission notification signal indicating the transmission timing, to the receiver 2B, 2C via the transmission unit 11 (refer to FIG. 1 again). Upon receiving the beacon transmission notification signal, the receiver 2B, 2C wirelessly transmits a beacon signal B1, based on the received beacon transmission notification signal, according to a transmission order set by the setting operation switch, with a preset interval that prevents overlapping of the transmitted signals. Accordingly, the transmission timings of the beacon signals B1 do not overlap with each other among the receiver 2A and the like. The above-mentioned interval is an integral multiple of a time slot T1. Therefore, among the receiver 2A and the like, the time slots T1 defined by the beacon signals B1 are synchronized with each other, and the timings at which time is divided by the time slots T1 coincide with each other.

After each of the receiver 2A and the like has wirelessly transmitted the beacon signal B1 first, each receiver independently counts time based on the transmission timing of the beacon signal B1, defines time slots T1, and periodically transmits the beacon signal B1. Therefore, in each of the receiver 2A and the like, the transmission timing of the beacon signal B1 might be advanced or delayed relative to the normal timing, with lapse of time, due to a count time error, and thus the transmission timings of the beacon signals B1 might overlap with each other among the receiver 2A and the like.

For example, as shown in FIG. 21, it is assumed that the transmission timing of the beacon signal B1 from the receiver 2B is delayed, and the transmission timings of the beacon signals B1 partially overlap with each other between the receivers 2B and 2C. At this time, if there is a region where the signal arrival ranges of the receivers 2B and 2C overlap with each other, the beacon signals B1 interfere with each other in the region. Therefore, for example, when the wireless slave unit associated with the receiver 2C exists in the region, even if the wireless slave unit performs the reception process at the transmission timing of the beacon signal B1 from the receiver 2C, it is difficult for the wireless slave unit to detect the beacon signal from the receiver 2C among the received signals.

As a countermeasure against this problem, when wirelessly transmitting the beacon signal B1, the receiver 2A transmits a beacon transmission notification signal to the receiver 2B, 2C via wires, for every predetermined multiple frames F1. The receiver 2B, 2C receives the beacon transmission notification signal, and then the control microcomputer 23, serving as a transmission timing correction circuit, determines an amount of correction for the transmission timing of the beacon signal B1 by the wireless transmission/reception circuit 21, based on the received beacon transmission notification signal. Specifically, the control microcomputer 23, based on the received beacon transmission notification signal, obtains the original transmission timing at which the beacon signal B1 should be transmitted, and compares the obtained original transmission timing to the current transmission timing of the beacon signal B1. If there is a time lag between these timings, the control microcomputer 23 determines the time lag as an amount of correction for the transmission timing of the beacon signal B1.

The control microcomputer 23 generates, for each frame F1, correction information indicating the determined amount of correction, and indicating at which frame F1, counting from the current frame, the transmission timing of the beacon signal B1 should be corrected. Further, the control microcomputer 23 includes the generated correction information in the payload in the beacon signal B1, for each frame F1, up to a frame F1 immediately before transmission of the beacon signal B1 whose transmission timing is scheduled to be corrected, and notifies the correction information to the operation switch 3 and the like by using the wireless transmission/reception circuit 21. Then, when the control microcomputer 23 attempts to transmit the beacon signal B1 whose transmission timing is scheduled to be corrected, the control microcomputer 23 advances or delays the transmission timing by the amount of correction, thereby correcting the transmission timing so as to coincide with the original transmission timing.

Based on the correction information notified from the wireless transmission/reception circuit 21 and received by the wireless transmission/reception circuit 32 or the like, a definition circuit in each of the operation switch 3 and the like grasps the frame F1 at which the transmission timing of the beacon signal B1 should be corrected and the amount of correction. Then, the definition circuit, based on the information, corrects the estimated value of the transmission timing of the beacon signal B1 in the above-mentioned frame F1 and subsequent frames F1.

In the present modification, it is possible to avoid interference of the beacon signals transmitted from adjacent receivers among the receiver 2A and the like. Therefore, each receiver can accurately communicate with the operation switch 3 and the like in the corresponding group G1, by sharing the same carrier frequency among the receivers. Accordingly, it is possible to effectively utilize the limited frequency band region of the wireless communication system.

Further, even if either of the receivers 2B and 2C changes the beacon signal transmission timing, the operation switch 3 and the like in the group G1 corresponding to the receiver can follow the change of the transmission timing, based on the correction information notified from the receiver. Accordingly, it is possible to make a shift of the time slots less likely to occur between the receiver 2B, 2C and the operation switch 3 and the like.

### Reference Embodiment

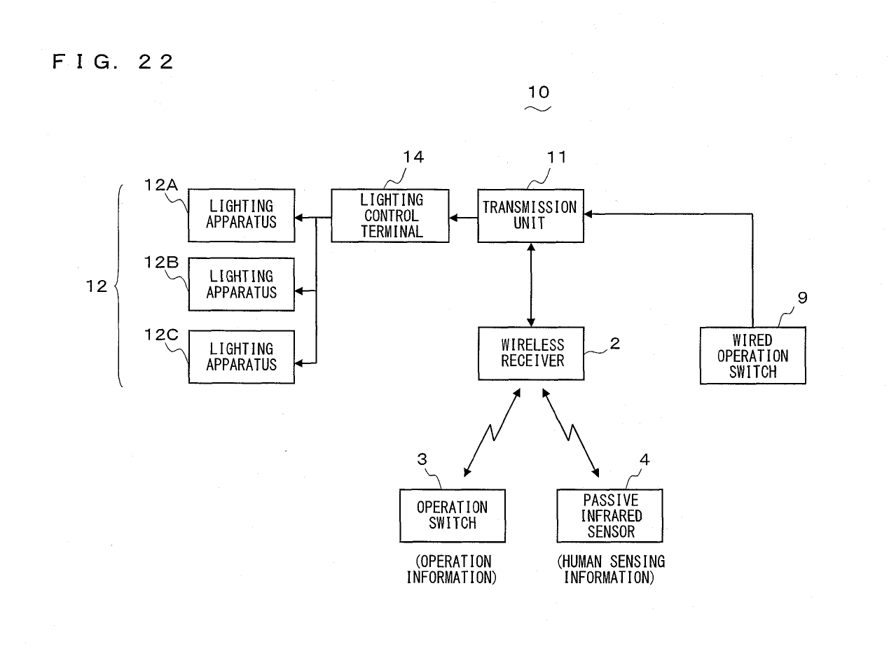

An equipment control system according to a reference embodiment of the present invention will be described with reference to the drawings. FIG. 22 shows the configuration of the equipment control system according to the present reference embodiment. The same components as those of the above embodiments are denoted by the same reference numerals, and the description thereof is omitted.

The equipment control system 10 includes a receiver 2, an operation switch 3, a passive infrared sensor 4, a transmission unit 11, lighting apparatuses 12A, 12B, and 12C (controlled equipment), and a lighting control terminal 14 (control equipment). The receiver 2 receives a radio signal transmitted from the passive infrared sensor 4. The transmission unit 11 transfers the signal received by the receiver 2 to the lighting control terminal 14. Based on the transferred radio signal, the lighting control terminal 14 controls ON/OFF of the lighting apparatus 12. Further, the equipment control system 10 includes, in addition to the operation switch 3, a wired operation switch 9 as an operation unit for operating ON/OFF of the lighting apparatus 12A and the like. Hereinafter, the lighting apparatuses 12A, 4B, and 4C (SIC: correctly it should be 12B, and 12C) are referred to as “lighting apparatus 12A and the like”. The number of the lighting apparatuses is not limited to that shown in FIG. 22.

When a user performs an operation to turn on or off the lighting apparatus 12A and the like by using the operation switch 3, the operation switch 3 wirelessly transmits, to the receiver 2, an operation information signal indicating the content of the user operation. The receiver 2 receives the operation information signal, and the transmission unit 11 transfers the received operation information signal to the lighting control terminal 14. When the above operation is performed, the wired operation switch 9 transmits, via a wire, an operation information signal indicating the content of the operation to the transmission unit 11, and then the transmission unit 11 transfers the operation information signal to the lighting control terminal 14. Based on the operation information signal transferred from the transmission unit 11, the lighting control terminal 14 controls ON/OFF of the lighting apparatus 12A and the like. The equipment control system 10 may include only one of the operation switch 3 and the wired operation switch 9.

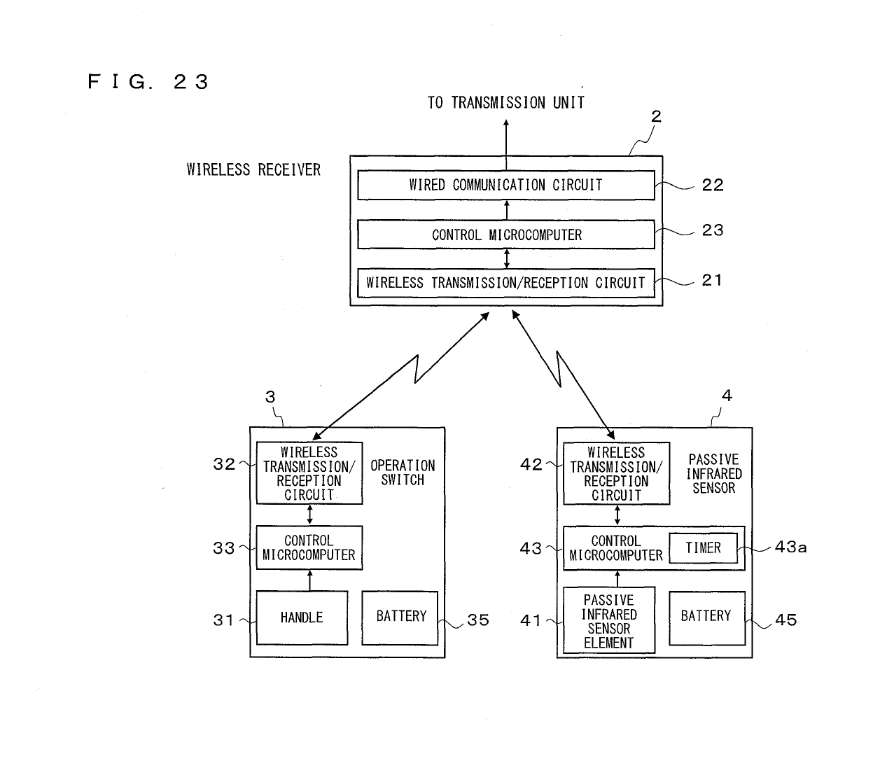

FIG. 23 shows the specific configurations of the receiver 2, the operation switch 3, and the passive infrared sensor 4 in the equipment control system 10 of the present reference embodiment. The passive infrared sensor 4 includes the above-mentioned passive infrared sensor element 41, wireless transmission/reception circuit 42, control microcomputer 43, and battery 45. The control microcomputer 43 includes a timer 43a, and performs communication control based on time measured by the timer 43a. The operation switch 3 includes the above-mentioned handle 31, wireless transmission/reception circuit 32, control microcomputer 33, and battery 35. The receiver 2 includes the above-mentioned wireless transmission/reception circuit 21, wired communication circuit 22, and control microcomputer 23.

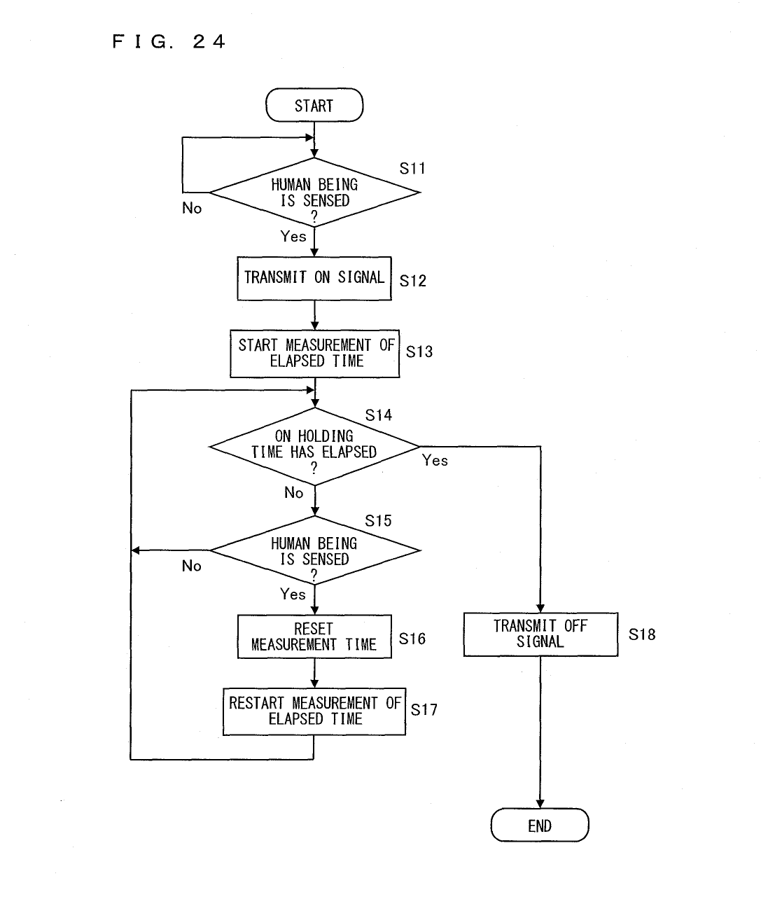

FIG. 24 shows the procedure of the communication control for the wireless transmission/reception circuit 42 by the control microcomputer 43 (passive infrared sensor 4). When presence of a human being is sensed by the passive infrared sensor element 41 (Yes in S11), the control microcomputer 43 causes the wireless transmission/reception circuit 42 to transmit an ON signal to turn on the controlled equipment (S12), and measures, by using the timer 43a, the time elapsed after the transmission (S13).

Before the time measured by the timer 43a reaches a predetermined ON holding period (No in S14), if the passive infrared sensor element 41 senses presence of a human being again (Yes in S15), the control microcomputer 43 causes the wireless transmission/reception circuit 42 not to transmit an ON signal. Further, the control microcomputer 43 resets the time measured by the timer 43a (S16), and restarts measurement of the elapsed time by using the timer 43a (S17). By this restart, the time elapsed after the reset of the measured time in the process of S16 is actually measured. When the passive infrared sensor does not sense a heat-radiating body (No in S15), the control microcomputer 43 returns to the process of S14.

When the time measured by the timer 43a reaches the ON holding period (Yes in S14), the control microcomputer 43 causes the wireless transmission/reception circuit 42 to transmit an OFF signal to turn off the lighting apparatus 12A and the like.

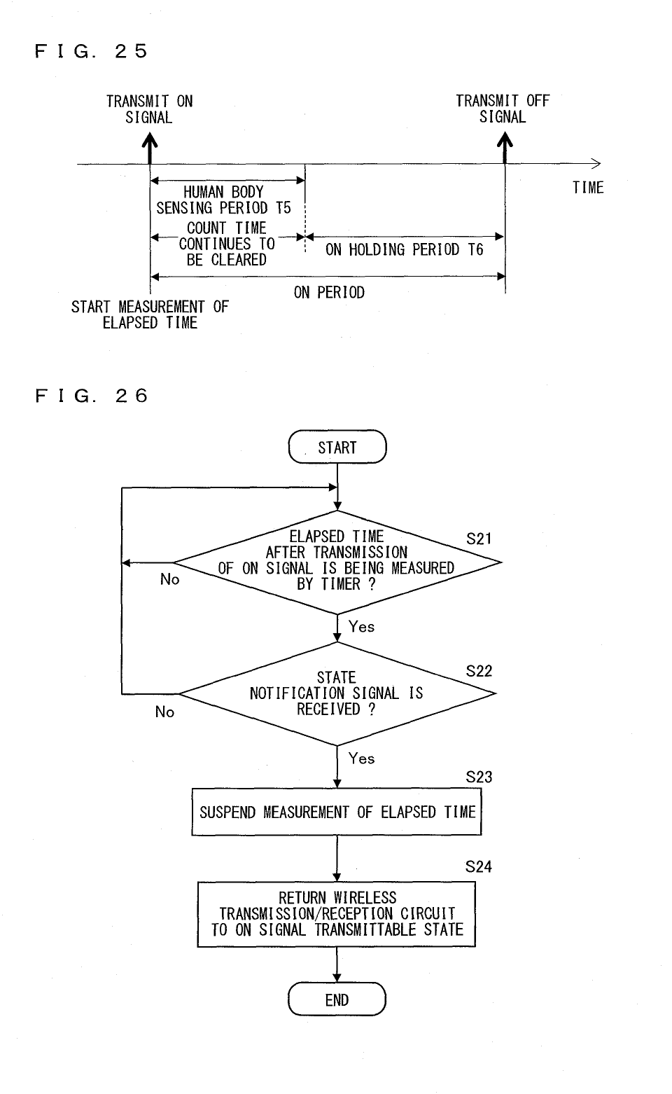

FIG. 25 shows transmission timings of an ON signal and an OFF signal by the wireless transmission/reception circuit 42. When the passive infrared sensor element 41 senses presence of a human being, the wireless transmission/reception circuit 42 transmits an ON signal. Thereafter, if the passive infrared sensor element 41 continues to sense the presence of the human being for a human sensing period T5, reset of the measured time by the timer 43a and restart of measurement of the elapsed time by the timer 43a are repeated during the period T5. After the passive infrared sensor element 41 has ceased to sense the presence of the human being, if the time measured by the timer 43a reaches an ON holding period T6 without a human body being sensed by the passive infrared sensor element 21 again, the wireless transmission/reception circuit 42 transmits an OFF signal.

By the way, it is assumed that, after the passive infrared sensor 4 has transmitted an ON signal and the lighting apparatus 12A and the like have been turned on based on the ON signal, a user might perform, before the ON holding period T6 elapses, an operation to turn off the lighting apparatus 12A and the like by using the operation switch 3 or the wired operation switch 9. In this case, the passive infrared sensor 4 need not transmit an OFF signal.

Control to be performed when the above-mentioned operation has been performed will be described with reference to FIGS. 1 and 2 again. Upon receiving a signal indicating the above-mentioned operation from the wired operation switch 9, the transmission unit 11 transfers the signal to the receiver 2. In the receiver 2, the wired communication circuit 22 receives the signal, and the wireless transmission/reception circuit 21 transmits, to the passive infrared sensor 4, a state information signal indicating that the lighting apparatus 12A and the like are to be tuned off. Also when the wireless transmission/reception circuit 21 receives a signal indicating the above operation from the operation switch 3, the wireless transmission/reception circuit 21 transmits the state information signal to the passive infrared sensor 4.

FIG. 26 shows a control process performed by the control microcomputer 43 (passive infrared sensor 4) in the above-mentioned case. While the timer 43a is measuring the time elapsed after the transmission of the ON signal (Yes in S21), if the state information signal is received by the wireless transmission/reception circuit 21 (Yes in S22), the control microcomputer 43 causes the timer 43a to suspend the measurement (S23). Usually, an OFF signal is transmitted when the time measured by the timer 43a has reached the ON holding period. Therefore, by suspending the measurement, no OFF signal is transmitted even when the measured time has reached the ON holding period. Further, the control microcomputer 43 restores the wireless transmission/reception circuit 21 to the state where the wireless transmission/reception circuit 21 can receive an ON signal (S24). This state switching causes the wireless transmission/reception circuit 21 to be in the state where the wireless transmission/reception circuit 21 transmits an ON signal when the passive infrared sensor element 41 senses presence of a human being.

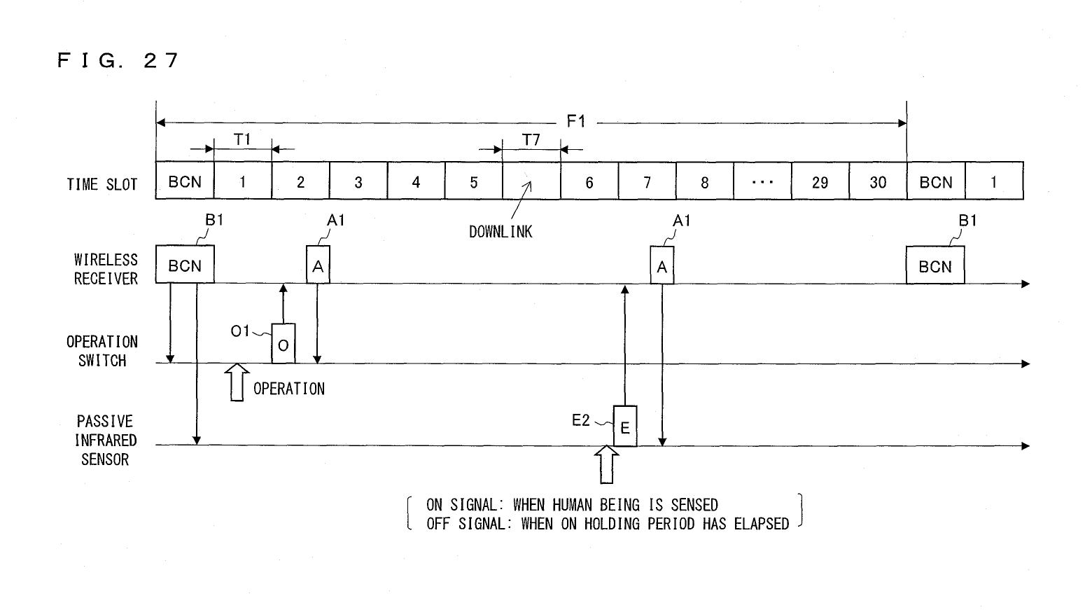

Next, a communication method and a communication operation along the communication method between the passive infrared sensor 4 and the operation switch 3 (hereinafter collectively referred to as “passive infrared sensor 4 and the like”) and the receiver 2 will be described with reference to FIG. 27 as well as FIGS. 22 and 23. FIG. 27 shows examples of the communication method and the communication operation. The communication is actually performed among the wireless transmission/reception circuits 21, 42, and 32 constituting the receiver 2 and the passive infrared sensor 4 and the like, respectively. However, for convenience of description, the receiver 2 and the passive infrared sensor 4 and the like will be described as major units for transmission, hereinafter.

As the communication method, the slotted ALOHA scheme is adopted, in which communication time is divided into frames F1 of a constant time length, each frame F1 is divided into a plurality of time slots of a constant time length, and communication is performed in units of time slots T1. The passive infrared sensor 4 and the like are synchronized with the time slots T1, and transmit signals by using arbitrary time slots T1, respectively.

The receiver 2 generates a beacon signal B1 that defines time slots T1, and wirelessly transmits the beacon signal B1 to the passive infrared sensor 4 and the like. The passive infrared sensor 4 and the like receive the beacon signal B1. The receiver 2 and the passive infrared sensor 4 and the like define time slots T1 based on the transmitted beacon signal B1 and the received beacon signal B1, respectively, and establish synchronization with the time slots T1. The beacon signal B1 is transmitted periodically (specifically, every frame F1) in order to realize continuous and accurate synchronization establishment. The beacon signal B1 is provided at the beginning of each frame F1, and a period from a beacon signal B1 to a time slot T1 immediately before a next beacon signal B1 is set as one frame F1. Among the time slots T1, a specific downlink-dedicated time slot T7 has previously been determined, which will be described later. The number of the time slots T1 in each frame F1 is not limited to that shown in FIG. 27.

The passive infrared sensor 4 transmits, to the receiver 2, a signal E2 that is either an ON signal or an OFF signal such that an ON signal is transmitted at the time of human sensing, and an OFF signal is transmitted by using a time slot T1 immediately after the ON holding period has elapsed. When a user operates ON/OFF of the lighting apparatus 12A and the like by using the handle 31, the operation switch 3 transmits, to the receiver 2, an operation information signal O1 indicating the content of the operation, by using a time slot T1 immediately after the user operation.

Upon receiving the signal from the passive infrared sensor 4 or the operation switch 3, the receiver 2 returns, as a response, an acknowledgement signal A1 to the passive infrared sensor 4 or the operation switch 3 as the transmission source, by using the time slot T1 at which the receiver 2 has received the signal. The acknowledgement signal A1 is a signal that notifies completion of reception of each information signal.

The passive infrared sensor 4 or the like (control microcomputer 43, 33) estimates transmission timing of a beacon signal B1 from the receiver 2. Since it is defined that the receiver 2 periodically transmits a beacon signal for every frame F1, it is possible to estimate the transmission timing of the beacon signal B1 based on the definition. Further, in order to save the battery 45, 35, the wireless transmission/reception circuit 42, 32 is switched to the drive mode only at the estimated transmission timing, the time slot T1 in which the wireless transmission/reception circuit 42, 32 transmits the signal and receives the acknowledgement signal A1 from the receiver 2, and the downlink dedicated time slot T7. Then, the wireless transmission/reception circuit 42, 32 switched to the drive mode performs a process of receiving the beacon signal B1 and the acknowledgement signal A1. This switching is performed by the control microcomputer 43, 33 turning on supply of power from the battery 45, 35 to the wireless transmission/reception circuit 42, 32. Further, the reception process is a process performed for a signal received via the antenna, and includes a demodulation process. In order to further save the battery 45, 35, the wireless transmission/reception circuit 42, 32 may be switched to the drive mode, not for every frame F1 but for every multiple frames F1 that have previously been set.

By the way, in order to perform the reception process in synchronization with the timing at which the beacon signal B1 is transmitted from the receiver 2, it is necessary to detect the transmission timing first. Therefore, when the passive infrared sensor 4 or the like is powered on, the passive infrared sensor 4 or the like performs the reception process for at least a period of one frame F1. At this time, if the receiver 2 is also in the power-on state, since the beacon signal B1 is transmitted from the receiver 2 for every frame F1, the passive infrared sensor 4 or the like can receive the beacon signal B1 at least once during the above period. Then, the passive infrared sensor 4 or the like can detect the transmission timing of the beacon signal B1 from the receiver 2. After the passive infrared sensor 4 or the like has detected the transmission timing first after the power-on, the passive infrared sensor 4 or the like estimates the transmission timing of the beacon signal B1 from the receiver 2, and performs the reception process to receive the beacon signal B1 at the estimated transmission timing.

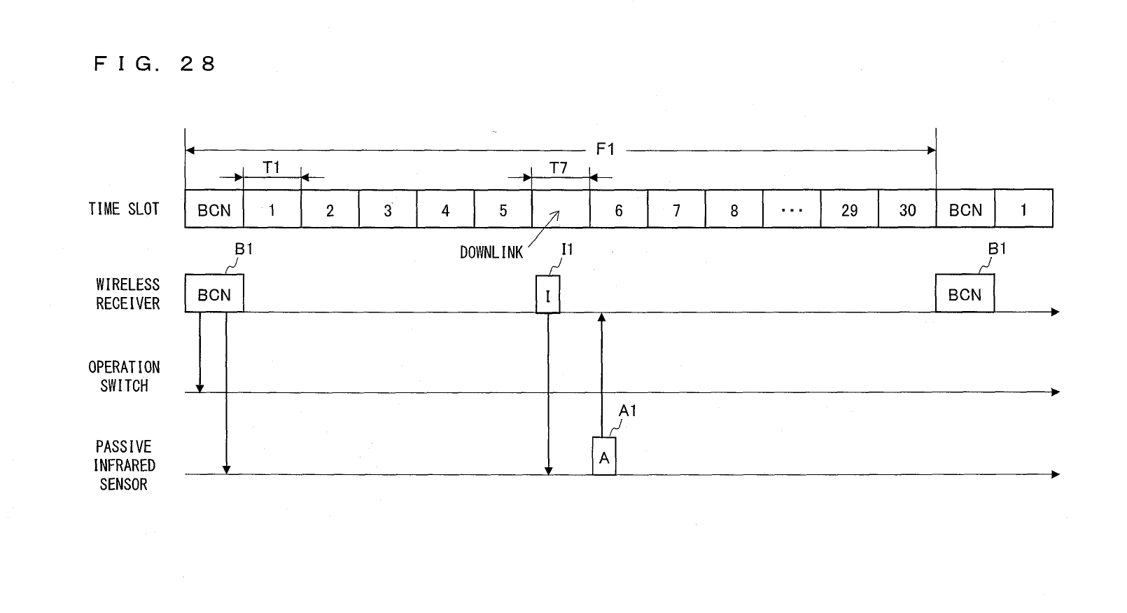

FIG. 28 shows timing at which the receiver 2 transmits a state information signal indicating that the lighting apparatus 12A and the like are turned off. The receiver 2 transmits the state information signal I1 to the passive infrared sensor 4 by using the downlink-dedicated time slot T7. The downlink-dedicated time slot T7 is a time slot in which only signal transmission from the receiver 2 to the passive infrared sensor 4 is allowed. The downlink-dedicated time slot T7 is provided in every frame F1, and a fixed time slot in each frame F1 is set as the downlink-dedicated time slot T7. Upon receiving the state information signal I1 by using the downlink-dedicated time slot T7, the passive infrared sensor 4 transmits an acknowledgement signal A1 indicating the reception of the state information signal I1, by using a next time slot, to the receiver 2.

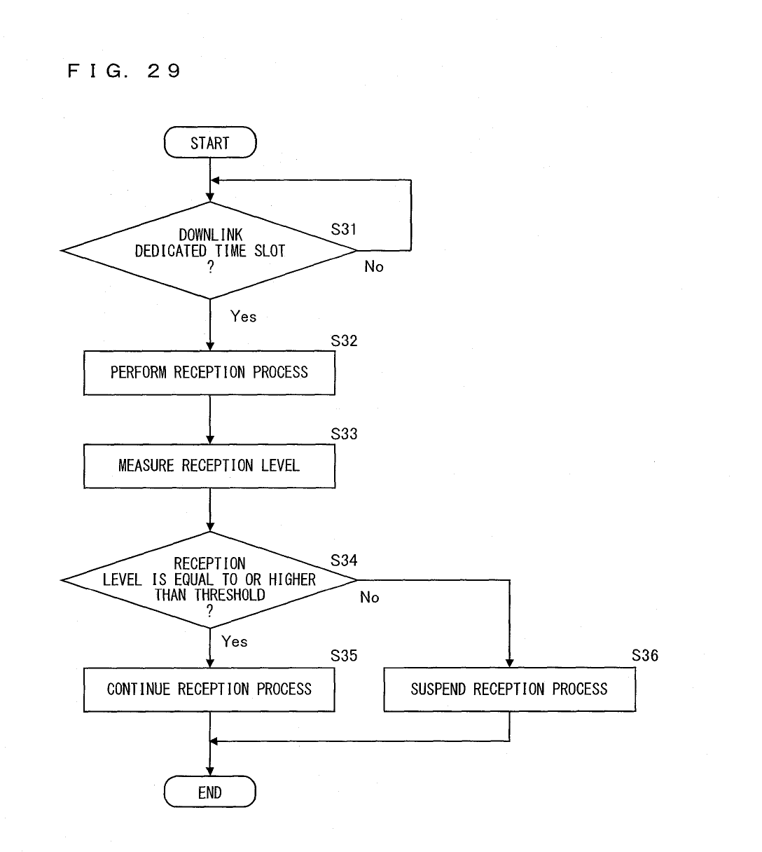

FIG. 29 shows a control process that the control microcomputer 43 (passive infrared sensor) performs at the downlink-dedicated time slot T7. At the downlink-dedicated time slot T7 (Yes in S31), the control microcomputer 43 causes the wireless transmission/reception circuit 21 (SIC: correctly it should be 42) to perform the reception process (S32), and measures the reception level of the wireless transmission/reception circuit 21 (SIC: correctly it should be 42) (S33). When the measured reception level is equal to or higher than a threshold (Yes in S34), the control microcomputer 43 continues the reception process by the wireless transmission/reception circuit 21 (SIC: correctly it should be 42) (S35). On the other hand, when the measured reception level is lower than the threshold (No in S34), the control microcomputer 43 suspends the reception process (S36).

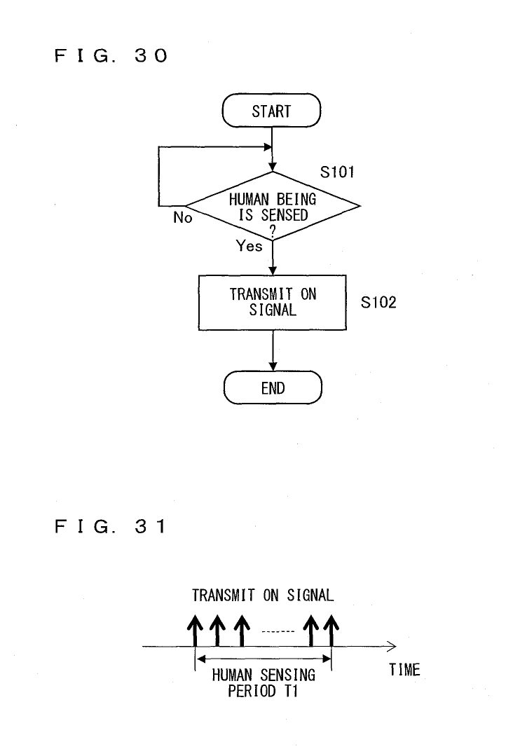

Now, problems of the conventional equipment control system will be described. In the conventional equipment control system, as shown in FIG. 30, when a passive infrared sensor senses presence of a human being (Yes in S101), the passive infrared sensor transmits an ON signal to turn on a lighting apparatus (S102). Then, as shown in FIG. 31, the passive infrared sensor transmits an ON signal every predetermined time, during a human sensing period T5 (refer to Japanese Laid-Open Patent Publication No. 10-69985, for example). Accordingly, the passive infrared sensor wirelessly transmits ON signals frequently during the human sensing period T5, resulting in a problem that power consumption by the passive infrared sensor increases.

In contrast, in the present reference embodiment, after a human being has been sensed by the passive infrared sensor element 41 and an ON signal has been transmitted from the wireless transmission/reception circuit 42, even if a human being is again sensed by the passive infrared sensor element 41 before the ON holding period T6 elapses, the wireless transmission/reception circuit 42 does not transmit an ON signal. Accordingly, it is possible to reduce the number of times of ON signal transmission by the passive infrared sensor 4. Thus, power consumption of the passive infrared sensor 4 can be reduced. As a result, power consumption of the battery 45 is reduced, and the duration in which the battery 45 can drive the passive infrared sensor 4 can be extended. Moreover, traffic in wireless communication can be reduced.

Further, when the ON holding period T2 (SIC: correctly it should be T6) has elapsed after transmission of an ON signal by the wireless transmission/reception circuit 42, the wireless transmission/reception circuit 42 transmits an OFF signal. Therefore, the lighting apparatus 12A and the like can be turned off based on the OFF signal. Accordingly, the lighting apparatus 12A and the like are prevented from remaining in the ON states, and thus ON/OFF of the lighting apparatus 12A and the like can be appropriately controlled.

After the passive infrared sensor element 41 has sensed a human being and the wireless transmission/reception circuit 42 has transmitted an ON signal, if the passive infrared sensor element 41 again senses a human being before the ON holding period T6 elapses, the ON holding period T6 is substantially extended. Accordingly, ON/OFF control for the lighting apparatus 12A and the like can be performed more precisely and suitably for the current situation.

Further, after the passive infrared sensor 4 has transmitted an ON signal, before the passive infrared sensor 4 transmits an OFF signal, if a use operates the operation switch 3 or the wired operation switch 9 to turn off the lighting apparatus 12A and the like and thereafter a human being is senses again, the passive infrared sensor 4 can immediately transmit an ON signal. Accordingly, the lighting apparatus 12A and the like can be turned on again, and thus the lighting apparatus 12A and the like can be reliably turned on in accordance with sensing of a human being by the passive infrared sensor 4.

Further, since the receiver 2 transmits the state information signal I1 by using the downlink-dedicated time slot T7, the passive infrared sensor 4 needs to perform the reception process at only the downlink-dedicated time slot T7 to receive the state information signal I1. Thereby, power required for the reception of the state information signal I1 can be reduced. Further, when the passive infrared sensor 4 performs the reception process at the downlink-dedicated time slot T7, if the receiver 2 does not transmit a state information signal I1 and the reception level is lower than the threshold, the passive infrared sensor 4 suspends the reception process. Therefore, wasteful power consumption can be reduced.

Further, since the wireless transmission/reception circuit 42, 32 is driven only for the specific purposes, power consumption of the battery 45, 35 due to the wireless transmission/reception circuit 42, 32 can be reduced as compared to the case where the wireless transmission/reception circuit 42, 32 is always in the drive mode. Moreover, since the passive infrared sensor 4 and the operation switch 3 are driven by the batteries 45 and 35, respectively, wiring work for feeder lines is not necessary, and thus instruction of the equipment control system 10 is facilitated.

Hereinafter, equipment control systems according to modifications of the above-mentioned reference embodiment will be described with reference to the drawings. The same components as those in the above-mentioned reference embodiment are denoted by the same reference numerals, and only difference from the reference embodiment will be described.

### First Modification of Reference Embodiment

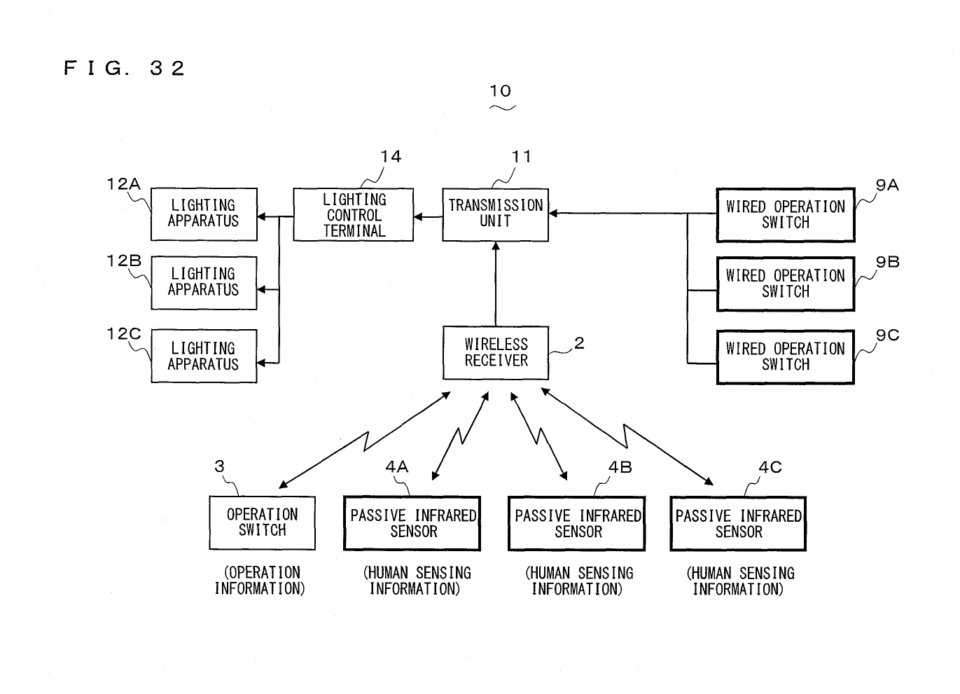

FIG. 32 shows the configuration of an equipment control system according to a first modification. In the equipment control system 10 of the present modification, N (N=3, for example) passive infrared sensors each having a configuration similar to the passive infrared sensor 4 of the above-mentioned reference embodiment are provided. N may be any integer not smaller than 2. These passive infrared sensors 4A, 4B, and 4C (hereinafter collectively referred to as “passive infrared sensor 4A and the like”) are assigned with N unique identification numbers so that one passive infrared sensor is assigned with one unique identification number. The N unique identification numbers are desirably set so that the remainders obtained by dividing each unique identification number by N are different from each other. Further, the equipment control system 10 includes wired operation switches 9A, 9B, and 9C (hereinafter collectively referred to as “wired operation switch 9A and the like”) each having a configuration similar to the wired operation switch 9 of the reference embodiment.

The passive infrared sensor 4A and the wired operation switch 9A are associated with a lighting apparatus 12A. When a user operates the wired operation switch 9A or when the passive infrared sensor 4A senses a human being, the lighting apparatus 12A is turned on or off. The passive infrared sensor 4B and the wired operation switch 9B are associated with a lighting apparatus 12B, and the passive infrared sensor 4C and the wired operation switch 9C are associated with a lighting apparatus 12C, in similar manner to that mentioned above. Therefore, after the passive infrared sensor 4A or the like has transmitted an ON signal to turn on the lighting apparatus 12A or the like, before the passive infrared sensor 4A or the like transmits an OFF signal, the lighting apparatus 12A or the like might be turned off by the wired operation switch 9A or the like.

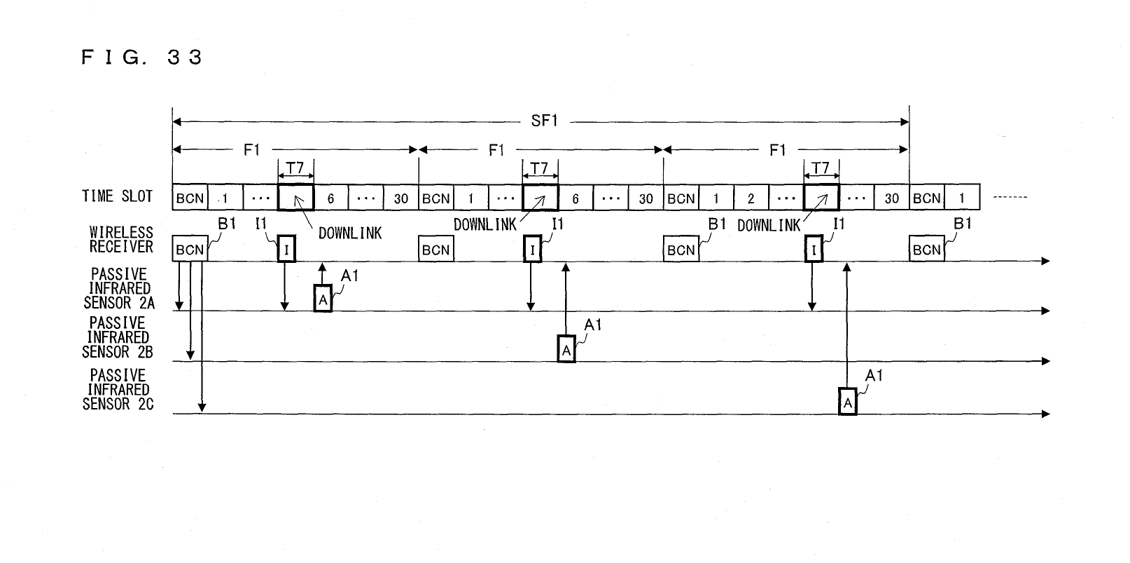

The receiver 2 and the passive infrared sensor 4A and the like of the present modification are configured on the assumption of the above case, and the configurations thereof will be described with reference to FIG. 33 as well as FIG. 23. FIG. 33 shows transmission timings of state information signals I1 by the receiver 2 in the present modification.

Assuming that one frame group consists of N frames F1, the receiver 2 includes, in a beacon signal B1 for each frame F1, order information indicating the order of the frames F1 in the frame group SF1, and notifies the order information to the passive infrared sensor 4A or the like. Therefore, once the passive infrared sensor 4A or the like has received the beacon signal B1, the passive infrared sensor 4A or the like can grasp the position of the current frame F1 in the frame group SF1.

When the receiver 2 attempts to transmit a state information signal I1 to any of the passive infrared sensor 4A and the like, a value of a remainder obtained by dividing the unique identification number of the passive infrared sensor by N is denoted by M. Then, the receiver 2 transmits the state information signal I1 by using the downlink-dedicated time slot T7 in the M-th frame in the frame group SF1. In this way, the receiver 2 transmits the state information signal I1 to the passive infrared sensor 4A and the like by using the downlink-dedicated time slots T7 in different frames F1.

It is assumed that, in any frame F1, the position of this frame grasped based on the order information notified by the receiver 2 coincides with the value of the remainder obtained by dividing the unique identification number of the passive infrared sensor 4A or the like including the control microcomputer 43 by N. At this time, in the passive infrared sensor 4A or the like, the control microcomputer 43 causes the wireless transmission/reception circuit 21 (SIC: correctly it should be 42) to perform the reception process by using the downlink-dedicated time slot T7 in this frame F1.

Now, signals transmitted from the receiver 2 and the passive infrared sensor 4A and the like (hereinafter referred to as transmission signals) will be described. The frame structure of each transmission signals is identical to that shown in FIG. 11 (refer to FIG. 11 again). A unique word b2 in the transmission signal from the receiver 2 and a unique word b2 in the transmission signal from each of the passive infrared sensor 4A and the like are set to be different from each other.

In the present modification, each of the passive infrared sensor 4A and the like performs the reception process by using a downlink-dedicated time slot T7 in one frame F1 among the N frames F1. Therefore, power consumption is reduced as compared to the case where the reception process is performed by using a downlink-dedicated time slot T7 in each frame F1. Further, since the cycle of performing the reception process for receiving the state information signal I1 in each of the passive infrared sensor 4A and the like is determined regardless of the length of the frame F1, even when setting of the length of the frame F1 is changed, the setting of the cycle need not be changed.

Further, the unique word b2 in the transmission signal from the receiver 2 and the unique word b2 in the transmission signal from each of the passive infrared sensor 4A and the like are different from each other. Therefore, when each of the passive infrared sensor 4A and the like performs the reception process by using the downlink-dedicated time slot T7, it is possible to quickly determine whether the signal being received is transmitted from the receiver 2 and therefore the reception process should be continued, or the signal being received is transmitted from another passive infrared sensor and therefore the reception process should be suspended.

### Second Modification of Reference Embodiment

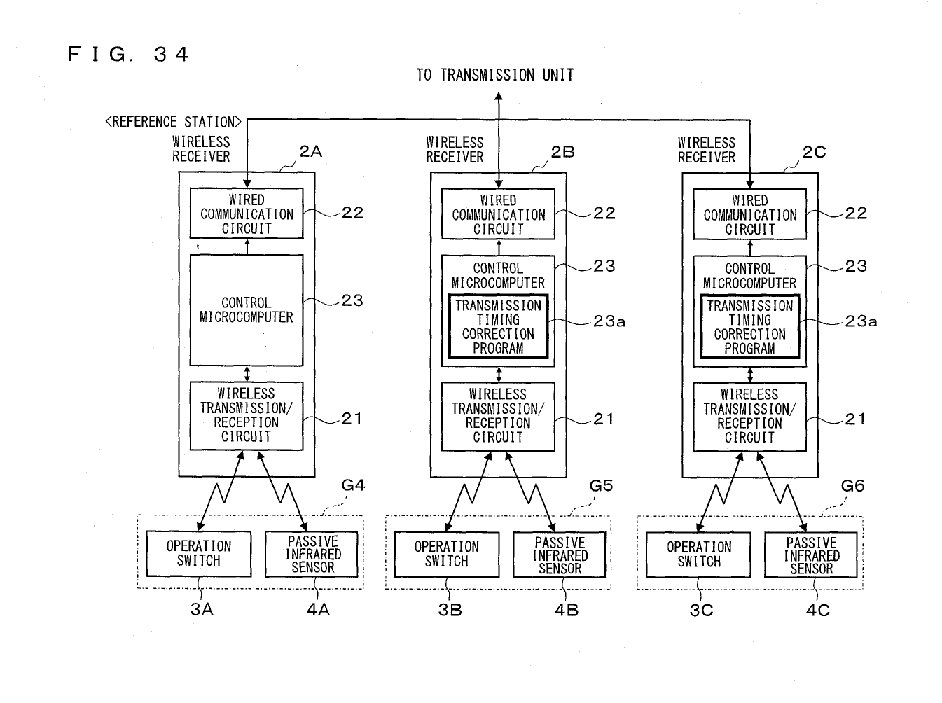

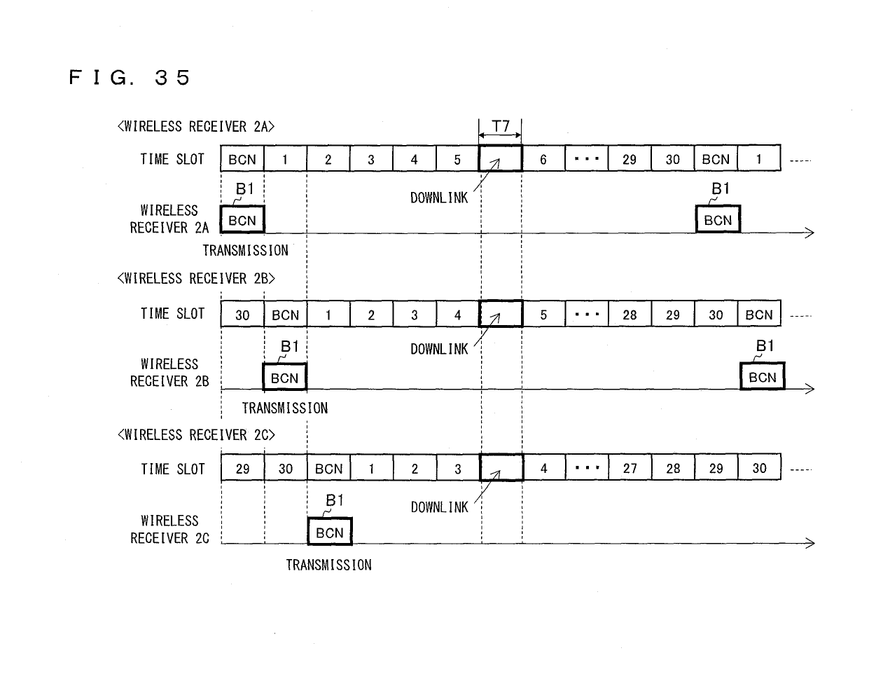

FIG. 34 shows the configurations of receivers, operation switches, and passive infrared sensors in an equipment control system according to a second modification, and FIG. 35 shows communication operations of the receivers in the equipment control system. The equipment control system 10 of the present modification includes a plurality of receivers 2A, 2B, and 2C (hereinafter collectively referred to as “receiver 2A and the like”) each having a configuration similar to the receiver 2 of the above-mentioned reference embodiment. Further, the equipment control system 10 includes a plurality of passive infrared sensors 4A, 4B, and 4C (hereinafter collectively referred to as “passive infrared sensor 4A and the like”) each having a configuration similar to the passive infrared sensor 4 of the reference embodiment. Further, the equipment control system 10 includes a plurality of operation switches 3A, 3B, and 3C (hereinafter collectively referred to as “operation switch 3A and the like”) each having a configuration similar to the operation switch 3 of the reference embodiment. One passive infrared sensor and one operation switch constitute one group. The passive infrared sensor 4A and the like and the operation switch 3A and the like constitute groups G4, G5, and G6 (hereinafter collectively referred to as “group G1 (SIC: correctly it should be G4) and the like”), respectively.

In the present modification, a case is assumed in which the receiver 2A and the like are installed so that the signal arrival ranges of the receiver 2A and the like do not substantially overlap with each other, and the group G4 and the like are associated with the receiver 2A and the like, respectively. The numbers of the receivers and the groups in the equipment control system 10 are not limited to those mentioned above. As described above, the passive infrared sensor 4A and the like and the operation switch 3A and the like have the same configurations as the passive infrared sensor 4 and the operation switch 3 of the above-mentioned reference embodiment, respectively, and therefore, will be described with reference to FIG. 23 again.

The group G4 and the like receive, by the wireless transmission/reception circuit 42, 32, beacon signals wirelessly transmitted from the wireless transmission/reception circuits 21 of the associated receiver 2A and the like, respectively. The above-mentioned association is realized by installing the group G4 and the like in the signal arrival ranges of the receiver 2A and the like, and performing setting so that the receiver 2A and the like and the group G4 and the like can communicate with each other, respectively.

A transmission timing correction program 23a for correcting transmission timing of a beacon signal is incorporated in the control microcomputer 43 of each receiver 2B, 2C. The control microcomputer 43 operates in accordance with the transmission timing correction program 23a, and functions as a transmission timing correction circuit. This function will be described later.

As shown in FIG. 35, the receiver 2A and the like are set so that transmission timings of beacon signals by the wireless transmission/reception circuits 21 do not overlap with each other. Further, the receiver 2A and the like are configured such that timings of downlink-dedicated time slots T7 coincide with each other, and do not overlap with the transmission timings of the beacon signals 1.

Now, the configuration to prevent the transmission timings of the beacon signals B1 of the receiver 2A and the like from overlapping with each other will be described in detail. Although communication between the receiver 2A and the like is performed by the wired communication circuits 22, the receiver 2A and the like will be described as major units for communication, with the wired communication circuits 22 being omitted.

One of the receiver 2A and the like has previously been set as a base station so as to transmit a beacon signal B1 first among the receiver 2A and the like. For example, it is assumed that the receiver 2A is set as a base station. The other receivers each include a setting operation switch (not shown) for setting a transmission order of beacon signals B1.

When wirelessly transmitting a beacon signal B1 first, the receiver 2A transmits a beacon transmission notification signal indicating transmission timing of the beacon signal B1, to the receiver 2B, 2C via the transmission unit 11 (refer to FIG. 22 again). Upon receiving the beacon transmission notification signal, the receiver 2B, 2C wirelessly transmits a beacon signal B1, according to the transmission order set by the setting operation switch, with a preset interval that prevents overlapping of the transmitted signals, based on the received beacon transmission notification signal. Accordingly, the transmission timings of the beacon signals B1 do not overlap with each other among the receiver 2A and the like. The above-mentioned interval is an integral multiple of a time slot T1. Therefore, among the receiver 2A and the like, the time slots T1 defined by the beacon signals B1 are synchronized with each other, and the timings at which time is divided by the time slots T1 coincide with each other.

After each of the receiver 2A and the like has wirelessly transmitted the beacon signal B1 first, the receiver independently counts time based on the transmission timing, defines time slots T1, and periodically transmits the beacon signal B1. Therefore, in each of the receiver 2A and the like, the transmission timing of the beacon signal B1 might be advanced or delayed relative to the normal timing, with lapse of time, due to a count time error, and thus the transmission timings of the beacon signals B1 might overlap with each other among the receiver 2A and the like.

For example, it is assumed that the transmission timing of the beacon signal B1 by the receiver 2B is delayed and thereby the transmission timings of the beacon signals B1 partially overlap with each other between the receivers 2B and 2C. At this time, if there is a region where the signal arrival ranges of the receivers 2B and 2C overlap with each other, the beacon signals B1 interfere with each other in the region. Therefore, for example, when the wireless slave unit associated with the receiver 2C exists in the region, even if the wireless slave unit performs the reception process at the transmission timing of the beacon signal B1 from the receiver 2C, it is difficult for the wireless slave unit to detect the beacon signal from the receiver 2C among the received signals.

As a countermeasure against this problem, when wirelessly transmitting the beacon signal B1, the receiver 2A transmits a beacon transmission notification signal to the receiver 2B, 2C via wires, for every predetermined multiple frames F1. The receiver 2B, 2C receives the beacon transmission notification signal, and the control microcomputer 23, serving as a transmission timing correction circuit, determines an amount of correction for the transmission timing of the beacon signal B1 by the wireless transmission/reception circuit 21, based on the received beacon transmission notification signal. Specifically, the control microcomputer 23, based on the received beacon transmission notification signal, obtains original transmission timing at which the beacon signal B1 should be transmitted, and compares the obtained original transmission timing to the current transmission timing of the beacon signal B1. If there is a time lag between these timings, the control microcomputer 23 determines the time lag as an amount of correction for the transmission timing of the beacon signal B1.

The control microcomputer 23 generates, for each frame F1, correction information indicating the determined amount of correction, and indicating at which frame F1, counting from the current frame, the transmission timing of the beacon signal B1 should be corrected. Further, the control microcomputer 23 includes the generated correction information in the payload in the beacon signal B1, for each frame F1, up to a frame F1 immediately before transmission of the beacon signal B1 whose transmission timing is scheduled to be corrected, and notifies the correction information to the group G5, G6 by using the wireless transmission/reception circuit 21. Then, when the control microcomputer 23 attempts to transmit the beacon signal B1 whose transmission timing is scheduled to be corrected, the control microcomputer 23 advances or delays the transmission timing by the amount of correction, thereby correcting the transmission timing so as to coincide with the original transmission timing.

Based on the correction information notified from the wireless transmission/reception circuit 21 and received by the wireless transmission/reception circuit 42, 32, the control microcomputer 43, 33 in the group G5, G6 grasps the frame F1 in which the transmission timing of the beacon signal B1 should be corrected, and the amount of correction. Then, the definition circuit, based on the information, corrects the estimated value of the transmission timing of the beacon signal B1 in the above-mentioned frame F1 and subsequent frames F1.

Now, the frame structure of the transmission signal of each of the receiver 2A and the like will be described. The frame structure is the same as that shown in FIG. 11 (refer to FIG. 11 again). The unique words b2 of the transmission signals of the receiver 2A and the like are set so as to be different from each other among the receivers.

In the present modification, it is possible to prevent the beacon signals B1 transmitted from adjacent receivers among the receiver 2A and the like from interfering with each other. Therefore, even if the same carrier frequency is shared among the receiver 2A and the like, the receiver 2A and the like can accurately communicate with the associated group G4 and the like, respectively. Accordingly, it is possible to effectively utilize the limited frequency band region.

Further, it is assumed that there is a region where the signal arrival ranges of the receiver 2A and the like overlap with each other. In this case, a state information signal I1 transmitted from a receiver by using a downlink-dedicated time slot T7 is prevented from colliding, in this region, with a beacon signal B1 and uplink signals transmitted to the receiver 2A and the like from the passive infrared sensor 4A and the like or the operation switch 3A and the like. Accordingly, it is possible to cause the passive infrared sensor 4A and the like to reliably receive the state information signal. Since the frequency of transmission of the state information signal I1 from each of the receiver 2A and the like by using the downlink-dedicated time slot T7 is very low, the possibility of collision between the state information signals I1 is low even if the timings of the downlink-dedicated time slots T7 are made coincide with each other among the receiver 2A and the like.

Further, when each of the passive infrared sensor 4A and the like performs the reception process by using the downlink-dedicated time slot T7, the following effect is obtained. That is, each of the passive infrared sensor 4A and the like can quickly determine whether the signal being received is transmitted from the associated receiver 2 among the receiver 2A and the like and therefore the reception process should be continued, or the signal being received is transmitted from a receiver other than the associated receiver and therefore the reception process should be suspended.

Further, even if either of the receivers 2B and 2C has changed the beacon signal transmission timing, the group associated with the receiver, between the groups G5 and G6, can follow the change of the transmission timing, based on the correction information notified from the receiver. Therefore, it is possible to make a shift of the time slots T1 less likely to occur between the receiver 2B, 2C and the group G5, G6, thereby enhancing the communication accuracy.

It is noted that the present invention is not limited to the embodiments and modifications described above, but various modifications can be devised in accordance with the intended use. For example, any of the above-described embodiments, modifications, and reference examples may be combined with another one.

The wiring method between the receiver 2, and the lighting control terminal 14 and the air-conditioning control terminal 15 may be a method based on DLC (Data Link Control). Alternatively, the communication method between them may be TDMA (Time Division Multiple Access). Alternatively, the communication method may be an asynchronous or contention-based priority control method such as CSMA (Carrier Sense Multiple Access). Further, the communication method may be FDMA (Frequency-Division Multiple Access) based on OFDM (Orthogonal Frequency Division Multiplexing), or may be a combination of some of the above access methods.

Any two or more units among the operation switch 3, the passive infrared sensor 4, the illuminance sensor 5, the temperature sensor 6, and the humidity sensor 7 may be integrated, and the wireless transmission/reception circuit and the control microcomputer may be shared. When a plurality of information signals are transmitted from the wireless transmission/reception circuit, the control microcomputer may automatically determine the priority levels of the information signals, and preferentially transmit information signals of higher priority levels.

Further, the beacon signal described in the first reference example of the first embodiment may have the same configuration as that described in the third modification of the first embodiment. In this case, since the temperature information signal and the humidity information signal are transmitted at the general slots T4, the number of bits in the bit sequence of the data section b7 may be set to the same number as the number of the general slots T4, and the bits in the bit sequence may be associated with the general slots in the order of numbers thereof.

Further, in the second modification of the second embodiment, the temperature to be measured by the temperature sensor element 37 may be the temperature of the atmosphere inside the passive infrared sensor 4 or outside the passive infrared sensor 4. In this case, in the correction table 38, temperature zones of the atmosphere inside or outside the passive infrared sensor 4 are associated with the count time errors of the core unit 33d.

Further, in the reference embodiment, the controlled equipment and the control equipment may be an air conditioner and an air-conditioning control terminal that controls ON/OFF of the air conditioner, respectively.

This application is based on Japanese Patent Applications Nos. 2011-036453, 2011-036455, 2011-036458, 2012-035726, and 2012-035729, and the contents thereof are incorporated herein by reference to the specification and the drawings of the above patent applications.

### DESCRIPTION OF THE REFERENCE CHARACTERS

1 wireless communication system
2 wireless receiver (wireless master unit)
23 control microcomputer (transmission timing correction circuit)
3 operation switch (wireless slave unit, operation unit)
32 wireless transmission/reception circuit
32a wireless communication oscillator
33 control microcomputer
33b (SIC: correctively it should be 33c) timer
33c (SIC: correctively it should be 33d) core unit (time slot definition circuit, count time value correction circuit, temperature compensation circuit)
33x memory (memory circuit)
34 operation clock oscillator
37 temperature sensor element
38 correction table
4 passive infrared sensor (wireless slave unit, event sensing sensor)
42 wireless transmission/reception circuit
43 control microcomputer
44 operation clock oscillator
5 illuminance sensor (wireless slave unit, event sensing sensor)
52 wireless transmission/reception circuit
53 control microcomputer
54 operation clock oscillator
6 temperature sensor (wireless slave unit, periodic measurement sensor)
62 wireless transmission/reception circuit
63 control microcomputer
64 operation clock oscillator
7 humidity sensor (wireless slave unit, periodic measurement sensor)
8 temperature/humidity sensor (wireless slave unit)
A1 acknowledgement signal (acknowledgement signal notifying completion of reception of an operation information signal or an event information signal)
B1 beacon signal
O1 operation information signal
E1 human sensing information signal (event information signal)
P1 temperature information signal (physical amount information signal)
P2 humidity information signal (physical amount information signal)
T1 time slot
t1 carrier sense period

1. A wireless communication system comprising:
a wireless master unit; and
a plurality of wireless slave units which receive a beacon signal periodically wirelessly transmitted from the wireless master unit, and wirelessly transmit a plurality of kinds of information signals to the wireless master unit, respectively, in synchronization with time slots defined by the beacon signal, wherein
the plurality of kinds of information signals have previously been assigned with priority levels, and
each of the plurality of wireless slave units is configured such that the higher the priority level of the information signal to be transmitted from the wireless slave unit is, the shorter a period of a carrier sense to be performed before the transmission is set.

2. The wireless communication system according to claim 1, wherein
the priority levels are set according to urgency levels of transmission.

3. The wireless communication system according to claim 2, wherein
the plurality of wireless slave units include: an operation unit which transmits an operation information signal when operated by a user; an event sensing sensor which senses, when an event occurs, the event, and transmits an event information signal; and a periodic measurement sensor which periodically measures a physical amount of environmental atmosphere, and transmits a physical amount information signal, and
the priority levels of the operation information signal and the event information signal are set to be higher than the priority level of the physical amount information signal.

4. The wireless communication system according to claim 3, wherein
at least two or more wireless slave units among the plurality of wireless slave units each are the periodic measurement sensor, and the periodic measurement sensors transmit the physical amount information signals by using different time slots.

5. The wireless communication system according to claim 3, wherein
the wireless master unit transmits various signals including the beacon signal which have previously been assigned with priority levels, in synchronization with the time slots, and
the higher the priority level of each of the signals to be transmitted is, the shorter a period of a carrier sense to be performed before the transmission is set.

6. The wireless communication system according to claim 5, wherein
the wireless master unit, when receiving the operation information signal or the event information signal, transmits an acknowledgement signal which notifies the operation unit or the event sensing sensor of completion of reception of the operation information signal or the event information signal, respectively, and
the priority level of the acknowledgement signal is set to be lower than the priority levels of the operation information signal and the event information signal, and higher than the priority level of the physical amount information signal.

7. The wireless communication system according to claim 5, wherein
the priority level of the beacon signal is set to be lower than the priority level of the physical amount information signal.

8. The wireless communication system according to claim 5, wherein
the wireless master unit, when receiving the physical amount information signal, includes an acknowledgement signal which notifies the periodic measurement sensor of completion of reception of the physical amount information signal, in a beacon signal scheduled to be transmitted next, and transmits the beacon signal including the acknowledgement signal.

9. The wireless communication system according to claim 8, wherein
when the wireless master unit has no acknowledgement signal to be transmitted to the periodic measurement sensor, the wireless mater unit suspends transmission of a beacon signal scheduled to be transmitted next.

10. The wireless communication system according to claim 9, wherein
the periodic measurement sensor transmits, to the wireless master unit, a request signal which requests transmission of a beacon signal, and
if the wireless master unit receives the request signal transmitted from the wireless slave unit when transmission of a next beacon signal is scheduled to be suspended, the wireless master unit changes the schedule and transmits the next beacon signal.

11. The wireless communication system according to claim 1, wherein
each of the plurality of wireless slave units comprises:
a wireless transmission/reception circuit which receives the beacon signal periodically wirelessly transmitted from the wireless master unit, and wirelessly transmits various signals to the wireless master unit, in synchronization with the time slots defined by the beacon signal;
a microcomputer which controls a process of transmitting the various signals from the wireless transmission/reception circuit; and
an operation clock oscillator which generates an operation clock signal for the microcomputer,
the wireless transmission/reception circuit comprises a wireless communication oscillator which generates a wireless communication clock signal for determining a carrier frequency of a signal to be transmitted, and
the microcomputer comprises:
a timer which counts time based on the operation clock signal generated from the operation clock oscillator;
a time slot definition circuit which defines the time slots by using the timer, starting from the reception timing of the beacon signal by the wireless transmission/reception circuit; and
a count time value correction circuit which corrects a count time value obtained by the timer, based on the wireless communication clock signal generated from the wireless communication oscillator.

12. A wireless slave unit comprising:
a wireless transmission/reception circuit which receives a beacon signal periodically wirelessly transmitted from a wireless master unit, and wirelessly transmits various signals to the wireless master unit, in synchronization with time slots defined by the beacon signal;
a microcomputer which controls a process of transmitting the various signals from the wireless transmission/reception circuit; and
an operation clock oscillator which generates an operation clock signal for the microcomputer, wherein
the wireless transmission/reception circuit comprises a wireless communication oscillator which generates a wireless communication clock signal for determining a carrier frequency of a signal to be transmitted, and
the microcomputer comprises:
a timer which counts time based on the operation clock signal generated from the operation clock oscillator;
a time slot definition circuit which defines the time slots by using the timer, starting from the reception timing of the beacon signal by the wireless transmission/reception circuit; and
a count time value correction circuit which corrects a count time value obtained by the timer, based on the wireless communication clock signal generated from the wireless communication oscillator.

13. The wireless slave unit according to claim 12, wherein
the count time value correction circuit counts the number of clocks of the wireless communication clock signal per unit time counted by the timer, and corrects the count time value based on the counted number of clocks.

14. The wireless slave unit according to claim 13, wherein
the timer detects that the unit time has elapsed every time the operation clock signal is counted by a reference number of clocks that has previously been set, and
the count time value correction circuit
divides the number of clocks of the wireless communication clock signal which have been counted in the unit time, by the number of clocks of the wireless communication clock signal which should be counted in an original unit time,
multiples an inverse of a value obtained by the division, by the current reference number of clocks, and
sets a number obtained by round off of a value obtained by the multiplication, as the reference number of clocks.

15. The wireless slave unit according to claim 12, wherein
the count time value correction circuit periodically performs a process of correcting the count time value.

16. The wireless slave unit according to claim 15, further comprising:
a temperature sensor element which measures a temperature of the wireless slave unit or a temperature of atmosphere inside or outside the wireless slave unit, wherein
the microcomputer further comprises a temperature compensation circuit which causes the temperature sensor to measure the temperature with a cycle shorter than a cycle of correction by the count time value correction circuit, and
the temperature compensation circuit causes the count time value correction circuit to perform a process of correcting the count time value, when a change amount or a change rate of the temperature currently measured by the temperature sensor element with respect to the temperature most recently measured by the temperature sensor element is equal to or greater than a threshold.

17. The wireless slave unit according to claim 16, further comprising:
a memory circuit having stored therein a table in which temperature zones of the wireless slave unit or temperature zones of atmosphere inside or outside the wireless slave unit are associated with count time errors caused by the timer, wherein
the count time value correction circuit
when the measured temperature is included in any of the temperature zones in the table, corrects the count time value based on the count time error associated with the temperature zone, with reference to the table, and
when the measured temperature is included in none of the temperature zones in the table, measures the count time error caused by the timer, and adds, in the table, the measured temperature associated with the count time error, and corrects the count time value based on the count time error.

18. A wireless communication system comprising:
the wireless slave unit according to claim 12; and
a plurality of wireless master units each including a wireless transmission circuit which periodically wirelessly transmits a beacon signal to the wireless slave unit, wherein
a plurality of the wireless slave units are provided,
the plurality of wireless slave units are associated with the plurality of wireless master units, respectively, and each of the plurality of wireless slave units receives, by the wireless transmission/reception circuit, the beacon signal wirelessly transmitted from the wireless transmission circuit of the associated wireless master unit, and
the plurality of wireless master units are configured so that transmission timings of the beacon signals from the wireless transmission circuits do not overlap with each other.

19. The wireless communication system according to claim 18, wherein
the time slot definition circuit estimates transmission timing of the beacon signal from the wireless transmission circuit, and
the wireless transmission/reception circuit is switched to a drive mode at the transmission timing estimated by the time slot definition circuit, and performs a process of receiving the beacon signal.

20. The wireless communication system according to claim 19, wherein
any one of the plurality of wireless master units transmits, via a wire, a beacon transmission notification signal indicating transmission timing of the beacon signal from the wireless master unit, to other wireless master unit(s),
the other wireless master unit(s) receives the beacon transmission notification signal, determines an amount of correction of the transmission timing based on the received beacon transmission notification signal, includes, in the beacon signal, correction information indicating the determined amount of correction, and notifies the wireless slave unit of the correction information by using the wireless transmission circuit, and
the time slot definition circuit corrects the estimated value of the transmission timing, based on the correction information that has been notified from the wireless transmission circuit and received by the wireless transmission/reception circuit.

21. A wireless slave unit used in the wireless communication system according to claim 1.

22. A wireless master unit used in the wireless communication system according to claim 1.
